(19) United States
(12) Patent Application Publication
(10) Pub. No.: US 2013/0191115 A1
(43) Pub. Date: Jul. 25, 2013

(54) Methods and Systems for Transcribing or Transliterating to an Iconphonological Orthography

(71) Applicants: Márcia dos Santos Suzuki, Kailua-Kona, HI (US); David Joel Hamilton, Kailua-Kona, HI (US); Edson Massamiti Suzuki, Kailua-Kona, HI (US)

(72) Inventors: Márcia dos Santos Suzuki, Kailua-Kona, HI (US); David Joel Hamilton, Kailua-Kona, HI (US); Edson Massamiti Suzuki, Kailua-Kona, HI (US)

(21) Appl. No.: 13/878,001

(22) PCT Filed: Nov. 3, 2011
(86) PCT No.: PCT/US11/59128

§ 371 Date: Apr. 5, 2013

Related U.S. Application Data
(60) Provisional application No. 61/410,273, filed on Nov. 4, 2010.

(51) Int. Cl. G06F 17/28

(52) U.S. Cl. CPC G06F 17/28
USPC 704/9

(57) ABSTRACT

Described are methods of developing an iconographical, phonological, orthography for any spoken language. Such “iconophonological” orthographies can be applied to languages for which no written form exists, or can be used to supplement or replace extant writing systems. The iconicity of the orthographies represents features of the vocal tract, which limits the number of icons to easily learned sets. This simplification, and the phonological correspondence between the icons and spoken language, makes the orthographies easy to learn. The orthographies can use letters that represent the linguistic characteristics of the spoken language. By incorporation of cultural aesthetics, some embodiments bring a sense of ethnic belonging, and thus create an immediate emotional bond with the orthography.

### COPYRIGHT NOTICE

© 2011 Legendum Pro Vita, LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### BACKGROUND

Writing is the use of symbols to fix language onto a tangible medium of expression. In order to understand the nature of writing we make reference to two fields of study. The first is Grammatology, the scientific field dedicated to describe and analyze the origin, evolution and typology of existing writing systems. The second is Linguistics, responsible for investigating the relations between the written and the spoken forms of language. Within the field of Linguistic, Phonology is the branch that deals precisely with the analysis of the speech sounds, being the most relevant in terms of explaining how the different writing systems reflect and represent different levels of sound structure.

Writing evolved from drawing. Ancient drawings developed into pictograms, stylized iconic graphs that represented actual things. Pictograms developed into logograms, conventional graphic forms that represent the morphemes, usually entire words. Later in history phonograms were invented, based in the concept of representing speech sound units, instead of entire words.

Ancient logograms explored the principle of iconicity, or resemblance, making the symbols easy to remember. The hieroglyph for “man” resembled the figure of a man. But because the number of words that can be uttered in any language is potentially infinite, logographic systems tend to have thousands of symbols. With the advent of phonograms, writing became much more economic, since the number of units of speech sounds used by any given language is much smaller than the potential number of words it can have. On the other hand, the very convenient principle of iconicity was abandoned.

Phonograms can express different levels of phonological representation. Syllabaries use the syllable as their unit of representation, as the Japanese Katakana, in opposition to segmental phonograms. Among the segmental phonograms, the main forms are abugidas, abjads and alphabets. In the abugidas, consonants are prominently represented and vowels are obligatory but less prominent, as in Devanagri (Hindi). The abjads basically represent only the consonants, leaving the vowels unmarked or sub-marked, as some forms of Arabic do. Alphabets represent the phonemes, both vowels and consonants, as do Greek. Some alphabets, like Hangul Korean, are partially featural, that is, they also represent some of the phonological features (or gestures) involved in the production of the phonemes.

Nearly all existing orthographies are not indigenous, but foreign. They were not created or developed for the specific language they represent, but were historically borrowed from foreign languages. Because languages are so diverse, the orthographies had to be largely adapted, adjusted or even distorted in order to serve the linguistic characteristics of the new languages. Orthographies that appear as diverse as Arabic, Latin, Hindi, Korean and even the Cherokee Syllabary, are all derived from possibly only one script created at the Middle Bronze Age in Serabit, Asia, and spread as a side effect of its users migration or expansion. Even this ancient Proto-Sinaitic alphabet, put together by illiterate Canaanite turquoise miners, was itself already a frail adaptation of the Egyptian hieroglyphs. In many places of the world certain writing systems were (and still are) ineffective precisely because of a lack of cultural bond.

In the course of this historical world-wide process of script adaptation, and due to natural process of language change through the centuries, most writing systems lost its original logic of representation, giving origin to many flawed hybrid orthographies. Hybrid systems mix different and even incompatible levels of phonological representation resulting in very complex orthographies. Japanese, for instance, mixes Chinese characters, which are logograms, with several types of syllabic phonograms that stand for the Japanese affixes. English orthography is an alphabetic phonogram in which the letters represent phonemes only eventually. Instead of employing a one-to-one relation between letters and phonemes, English employs dozens of arbitrary combinations of letters, called phonics, which have usually a several-to-one or a one-to-several relation with the phonemes. The English phoneme /f/ occurring in coda position, for instance, is represented as “if” in the word “off”, as “gh” in the word “enough” and as “ph” in the word “hieroglyph”. In a perfectly phonological alphabet, usually called a phonemic alphabet, the phonemes and letters would correspond perfectly in two directions: a writer could predict the spelling of a word given its pronunciation, and a speaker could predict the pronunciation of a word given its spelling.

Most extant phonographic orthographies are not only foreign, but also hybrid and employ symbols that are totally arbitrary. No wonder why years of schooling are necessary for students to acquire reading and writing skills. It also explains the high levels of illiteracy even in countries where literacy is highly valued, and also the high level of functional illiteracy even after many years of schooling. Unfortunately, the situation is not better if logographic systems are used. A vast number of logograms are required to represent a language, so becoming literate in a logographic system can take many years. As a consequence, many speakers of languages represented logographically are functionally illiterate.

Featural scripts represent the utterances using symbols that provide visual representations of the phonological features involved in the production of speech sounds. For instance, all sounds pronounced with the lips, that is, all sounds that share a positive specification for the feature (labial), may have some element in common. Visible Speech, also known as the Physiological Alphabet, is an example of a featural script invented in 1867 by Alexander Melville Bell, the father of Alexander Graham Bell, inventor of the telephone. Visible Speech, however, was never intended to be used as an orthographic system, that is, a system that would allow people to creatively and productively read and write their own languages. It was created as a phonetic alphabet, as an aid to help hearing-impaired people to learn how to speak, or to teach foreigners how to pronounce the English words. In this sense, Visual Speech was not an orthographic writing system, but a pronunciation transcribing tool, similar to IPA—the International Phonetic Alphabet.

Some orthographies are partially featural. In the Latin or Roman alphabet, for example, the letters “b” and “p” look similar and are both articulated using the lips; however, the letter “m” is also articulated using the lips, but is completely dissimilar, while the similar-looking “q” is not labial. In Korean hangul, all four labial consonants are based on the same basic element. This pattern does not hold across the orthography, however, so the featural elements of hangul tend to pass unnoticed.

### BRIEF DESCRIPTION OF THE FIGURES

FIG. 1 is a flowchart 100 illustrating a method of developing an iconographical, phonological, orthography for any spoken language. Such “iconophonological” orthographies can be applied to languages for which no written form exists, or can be used to supplement or replace extant writing systems.

FIG. 2 is a flowchart 200 detailing how an onset consonant phoneme is derived in accordance with one embodiment. The derivation of each phoneme proceeds as follows.

FIG. 3A depicts exemplary iconic representations of the five organs of constriction, each one of them implying a corresponding place of articulation where the constriction is produced, used as glyphs for expressing consonant phonemes.

FIG. 3B illustrates the iconic representations of the primary organs of constriction introduced in FIG. 3A absent cross sections 212 for ease of illustration.

FIG. 4 depicts six diacritical marks, or diacritics, that can be used alone or in combination with other glyphs to complement the phonological specifications of the segment of General American (GA) English.

FIG. 5 is a flowchart 500 illustrating the application of the procedure of FIG. 1 to the consonant phoneme “V,” as in Victor, to develop an iconophonological grapheme in accordance with one embodiment.

FIG. 6 depicts a consonant constellation 600 for GA English arranged in columns by primary organ of articulation.

FIG. 7 is a flowchart 700 detailing how a vowel phoneme is derived in accordance with one embodiment.

FIG. 8A depicts symbols relating vowel sounds to mouth and tongue position.

FIG. 8B illustrates exemplary iconic representations of phonological gestures used to express a pair of diphthongs, which are gliding monosyllabic speech sounds that start at or near the articulatory position for one vowel and move to or toward the position of another.

FIG. 9 is a flowchart 900 illustrating the construction of a vowel grapheme using the steps of FIG. 7.

FIG. 10 depicts a vowel constellation 1000 for GA English arranged in rows and columns to indicate the degree of openness and the degree of frontness, respectively.

FIG. 11 depicts two vowel graphemes in accordance with one embodiment.

FIG. 12 depicts five vowel graphemes, one for each diphthong in GA English.

FIG. 13 shows an iconophonological orthography for GA English in accordance with one embodiment.

FIG. 14 is a flowchart 1400 illustrating a method of organizing graphemes developed as discussed previously to formulate written words and sentences that parallel the writing structure normally used for the target language.

FIG. 15 is a flowchart 1500 illustrating a method of transliterating words expressed in a first orthography—GA English—into the iconophonological orthography depicted in FIG. 13.

FIG. 16 illustrates how a reader of the iconophonological orthography in accordance with the embodiments described in connection with FIG. 13 can sound out the word “system” derived in the example of FIG. 15.

FIG. 17A illustrates how the graphical representations of the single-syllable word “springs,” a CCCVCCC syllable, can be simplified in accordance with one embodiment.

FIG. 17B illustrates how “strengths,” a CCCVCCC syllable, can be simplified using the procedure discussed in connection with FIG. 17A.

FIG. 17C depicts iconophonological representations 1710, 1715, 1720, and 1725 of single-syllable words to illustrate how such syllables can be condensed in accordance with one embodiment.

FIG. 18 is a flowchart 1800 illustrating a method by which orthographies in accordance with some embodiments can be stylized to reflect cultural aesthetics of the population for which the new orthography is to be introduced. Such adaptations can increase sociolinguistics acceptance of the orthography.

FIG. 19 depicts an orthography in accordance with an embodiment that includes 31 graphemes to represent Beijing Mandarin.

FIG. 20 depicts graphic elements used to represent labial consonants, and references them to phonemes, phonetics, and Pinyin forms to facilitate pronunciation.

FIG. 21 depicts graphemes used to represent velar and alveolar consonants, and references them to phonemes, phonetics, and Pinyin forms to facilitate pronunciation, and to a reference code for use with an embodiment of a Uniskript™ Mandarin (UM) keyboard.

FIG. 22 depicts graphemes used to represent palatal/retroflex consonants and single vowels with the same references provided previously.

FIG. 23 depicts graphemes used to represent crescent diphthongs, decrescent diphthongs, and triphthongs with the same references provided previously.

FIG. 24 depicts graphemes used to represent high-high diphthongs, single vowels with alveolar coda, and single vowels with velar coda with the same references provided previously.

FIG. 25 depicts graphemes used to represent single vowels with retroflex coda, vowel glides with alveolar coda, and vowel glides with velar coda using the same references provided previously.

FIG. 26 depicts graphemes used to represent tones using the same references provided previously.

FIGS. 27A and 27B are two sheets of a questionnaire that may be employed by an analyst to develop orthographies in the manner detailed above.

FIG. 28 provides a brief, general description of a suitable computing environment in which the claimed subject matter may be implemented.

### DETAILED DESCRIPTION

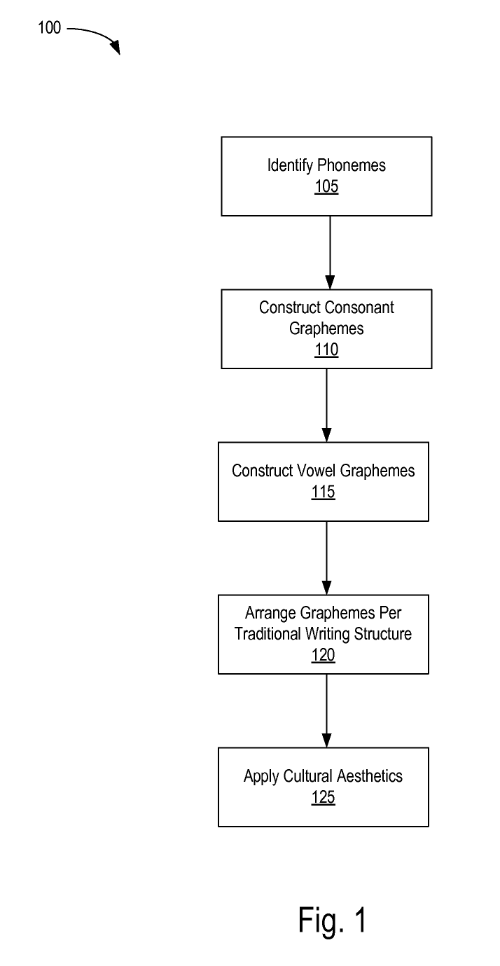

FIG. 1 is a flowchart 100 illustrating a method of developing an iconographical, phonological, orthography for any spoken language. Such “iconophonological” orthographies can be applied to languages for which no written form exists, or can be used to supplement or replace extant writing systems. As described below in detail, the iconicity of the orthographies represents features of the vocal tract, which limits the number of icons to easily learned sets. This simplification, and the phonological correspondence between the icons and spoken language, makes orthographies produced in accordance with the embodiment of FIG. 1 considerably easier to learn than conventional orthographies.

Iconophonological orthographies of the type disclosed herein attain economy by making use of the most primitive level of phonological representation acquainted by the current Phonological Theory—the phonological gesture/feature. This ultimate depth in phonological representation casts away hybridism and makes it possible to represent even the most complex language using less than thirty symbols, each one of them having a transparent one-to-one correspondence with one specific phonological gesture/feature of that language.

These iconophonological orthographies also break with the foreignness in writing by allowing the creation of writing systems that are totally indigenous, using letters designed objectively to represent the linguistic characteristics of the spoken language. By incorporation of cultural aesthetics, some embodiments bring a sense of ethnic belonging, and thus create an immediate emotional bond with the orthography.

The iconophonological orthography of the type disclosed herein breaks with the arbitrariness in writing by bringing back the iconicity principle, allowing systems that are intuitive and easily learned. The symbols graphically resemble the pronunciation of the phonological gesture involved in the sound depicted.

The process of FIG. 1 begins with the identification of all phonemes in the target language (105). As is well understood by those of skill in the art, phonemes are traditionally described as the smallest segmental units of sound used to form meaningful contrasts between utterances. Phonological dictionaries break words into those meaningful segmental units, and are readily available for many languages and their variants. The vowel graphemes can be derived before the consonant graphemes, or the consonant and vowel graphemes can be derived using a hybrid process.

Next, consonant and vowel graphemes are constructed for each phoneme (110 and 115). As used herein, a “grapheme” is a unit of written language that corresponds to a combination of features or gestures comprising a sound. Graphemes include one or more glyphs, which in this context are individual marks that contribute to provide the full phonological specification of a grapheme. These constructions employ iconic and phonological graphical elements, as detailed below in connection with later figures. The order of 110 and 115 can be reversed, and there is no need to complete one type of grapheme before working on another.

The writing systems for different languages arrange their symbols differently. The orthography used for the English language, for example, represents language segmentally using letters and words written from left to right. Other writing structures are e.g. syllabic, and may be arranged along different axes. Though not necessary, orthographies in accordance with the embodiments described herein are arranged in the manner of the traditional writing structure for the target language (120). Such arrangement facilitates adoption by those familiar with the traditional writing structure and facilitates interlineating iconophonological text with traditional writing.

In the final process of FIG. 1, cultural aesthetics can be applied to the iconophonological orthography developed in 105 through 120. This process gives the newly derived orthography an appearance consistent with the traditional writing structure, or may use other cultural cues to tailor the orthography to the people or culture that are the intended audience for the newly derived system. Adaptation of new orthographies to the cultural aesthetics of the target audience facilitates adoption.

The process outlined in FIG. 1 can be applied to any spoken language or variant thereof. For ease of illustration, the following examples are based on an English accent termed “General American,” for which suitable phonological frameworks are well known to those of skill in the art.

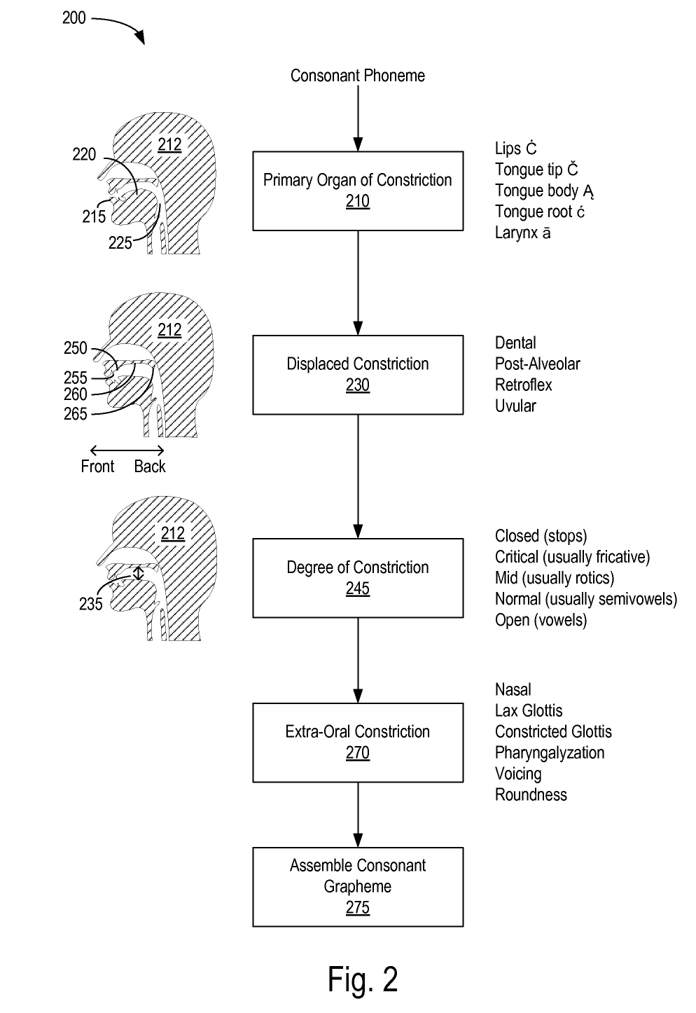

FIG. 2 is a flowchart 200 detailing how an onset consonant phoneme is derived in accordance with one embodiment. The derivation of each phoneme proceeds as follows. First, at 210, an organ of constriction is identified for the consonantal phoneme. This organ, illustrated in a cross section 212 of the human head that highlights the vocal tract, might be the lips 215, the tongue 220, or the larynx 225. In the instance of the tongue, the primary organ might be further specified as the tip, body, or root. As used herein, the “vocal tract” is made up of the cavities and structures above the vocal folds, and is used to shape and alter airflow and sound vibration into distinctive speech sounds. The vocal tract is commonly understood to include a laryngeal cavity, a pharynx, an oral cavity, a labial cavity and a nasal cavity.

Step 230 is to identify what, if any, is the displaced point of constriction, which is sometimes referred to as the point of articulation. Usually the organ of constriction produces its constriction in its neutral or implicit place or articulation. Neutrally placed constrictions are called “placed” constrictions. When the constriction organ is the (lower) lip, for instance, its neutral point of constriction is the (upper) lip. This is how the labial sounds are produced. However, if the organ of constriction produces constriction by moving away from its neutral position, advancing or retracting to touch a different point of constriction, the method specifies this process as “displaced” constriction. In the case of the lip, if instead of touching the upper lip, it retracts and touches the upper teeth, the sound produced will be a labio-dental one. This may be marked by a diacritic that represents the teeth placed above the grapheme for labial. In this example, the displaced constrictions can be produced in the dental point 250, the post-alveolar point 255, the retroflex point 260, and the uvular point 265.

Next, at step 245 the degree of vocal-tract constriction is selected from among the general categories for the language of interest. In this embodiment, these categories are: 1) closed, which is generally used for stops; 2) critical, which is generally used for fricative sounds; 3) mid, commonly applied to rhotics; 4) normal, for semivowels; and 5) open, for vowels.

Step 270 is to identify any extra-oral constriction used to enunciate the consonant under consideration. In this example, these extra-oral constriction possibilities are identified as nasal, lax glottis, constricted glottis, pharyngealization, voicing, and lip roundness. Finally, at step 275, an iconic grapheme is then assembled based on the findings from steps 210, 230, 245, and 270. As detailed below, graphemes include one or more glyphs, which in this context are individual marks that contribute to provide the full phonological specification of a grapheme.

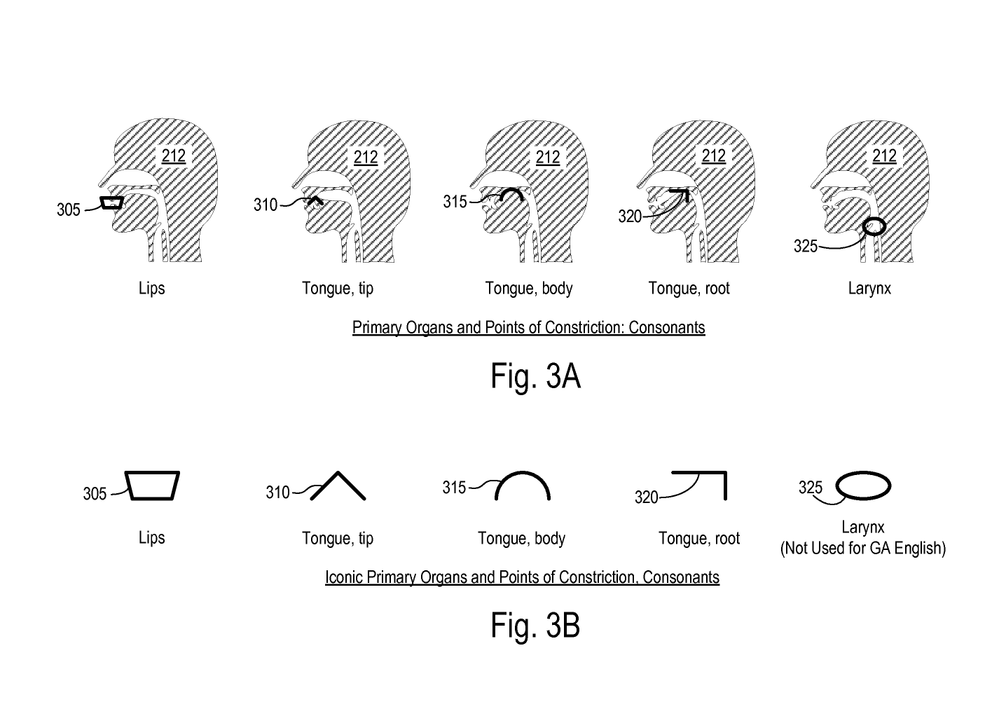

FIG. 3A depicts exemplary iconic representations of the five organs of constriction, each one of them implying a corresponding place of articulation where the constriction is produced, used as glyphs for expressing consonant phonemes. From left to right, a polygon 305 represents the lips, an inverted “V” 310 the tip of the tongue, an inverted “U” 315 the body of the tongue, a step 320 the root of the tongue, and an ellipse 325 the larynx.

FIG. 3B illustrates the iconic representations of the primary organs of constriction introduced in FIG. 3A absent cross sections 212 for ease of illustration. The following discussion details the development of an orthography of General American (GA) English. GA English may include but does not require the larynx representation for graphemes, so the larynx icon may be omitted.

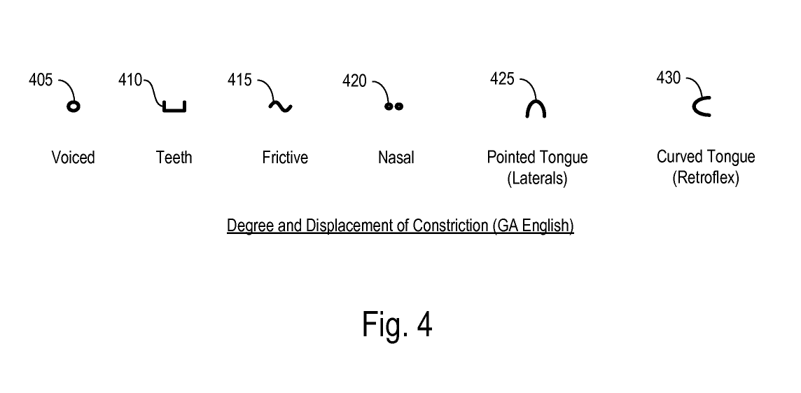

FIG. 4 depicts six diacritical marks, or diacritics, that can be used alone or in combination with other glyphs to complement the phonological specifications of the segment of GA English. These include a “voiced” diacritic 405, a “teeth” diacritic 410, a “fricative” diacritic 415, a “nasal” diacritic 420, a “lateral ” diacritic 425, and a “retroflex” diacritic 430. Voiced diacritic 405 indicates that the corresponding consonant is voiced; diacritic 410 that the corresponding consonant is enunciated using the teeth; diacritic 415 that the corresponding consonant is enunciated using enough friction to create a sibilant, hissing, or buzzing quality; nasal diacritic 420 that the corresponding consonant resonates in the nasal cavity (nose); tongue diacritic 425 that the corresponding consonant is enunciated using the laterals of the tongue lowered (as in the pronunciation of the English “L”); and tongue diacritic 430 that the corresponding consonant is articulated with a retroflex tongue (curved towards the back of the oral cavity).

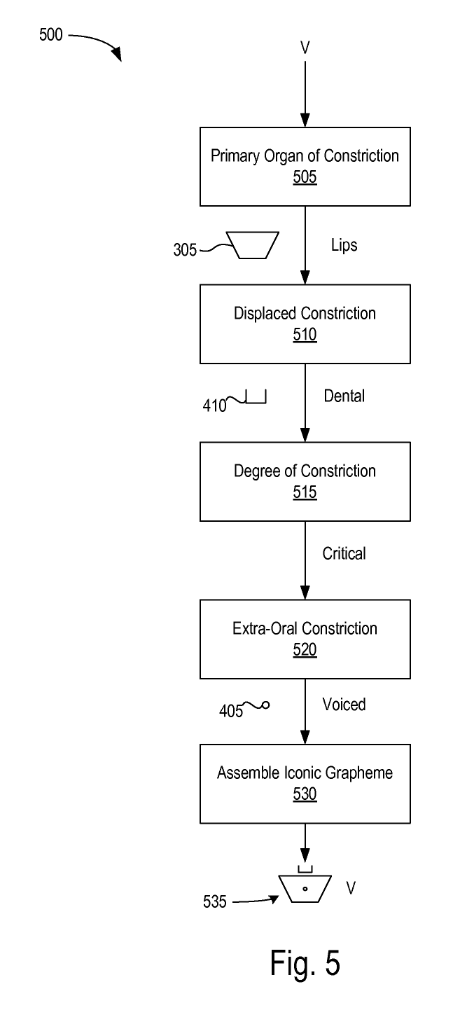

FIG. 5 is a flowchart 500 illustrating the application of the procedure of FIG. 1 to the consonant phoneme “V,” as in Victor, to develop an iconophonological grapheme in accordance with one embodiment. First, at 505, the lips are identified as the primary organ of constriction, and icon 305 of FIG. 3 is selected accordingly. (In general, the first digit of each numerically identified element refers to the Figure in which the element was introduced.) This identification can be done by anyone familiar with the pronunciation of the phoneme in question. The reader is invited to pronounce the “V” sound, and will doubtless observe that the lips are the primary organ of constriction, and not the tongue or larynx.

Next, place of constriction is characterized in 510. In enunciating the “V” sound, one will readily observe that the lower tip retracts to touch the upper teeth. The constriction is therefore displaced, and is consequently identified in 510. Teeth diacritic 410 is therefore selected to represent this point of articulation. The enunciation of the “V” sound also indicates that the degree of constriction is critical, and this is noted in 515, but this critical constriction is implied in any labio-dental articulation, so it need not be marked with a specific diacritic. An extra-oral constriction is required, however, as the “V” sound must be vocalized, or “voiced,” to distinguish it from the “F” sound. This attribute is noted using the diacritic 405 assigned to voicing. Finally, at 525, an iconic grapheme 530 is assembled using the identified collection of glyphs. Grapheme 535 includes all the information required to represent the phoneme for “V” in GA English, as this phoneme is the only voiced consonant formed using the lips and teeth.

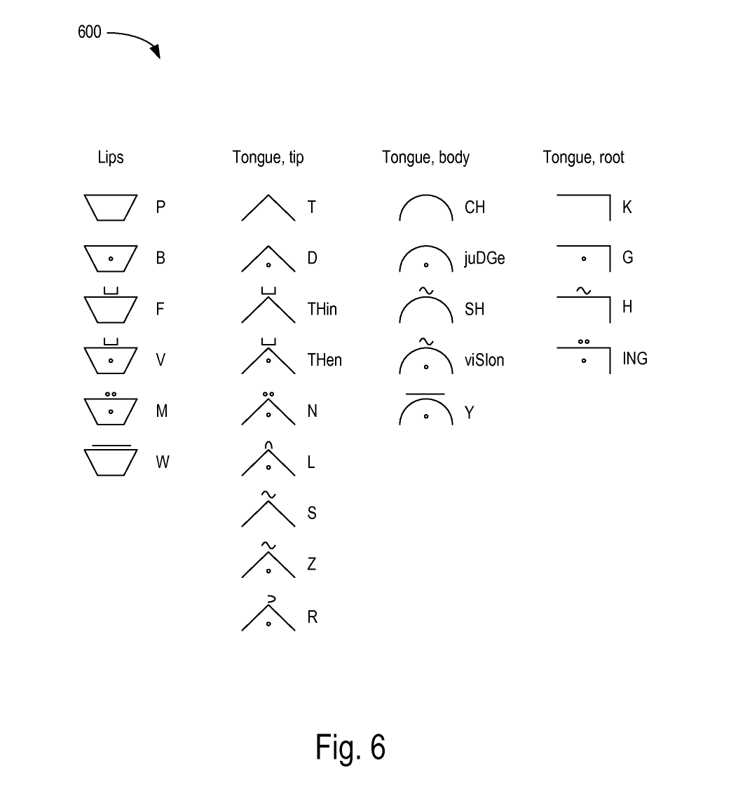

FIG. 6 depicts a consonant constellation 600 for GA English arranged in columns by primary organ of articulation. Constellation 600 was formed by repeating the process of FIG. 5 for each GA English consonant phoneme. From left to right, the columns represent: each consonant for which the primary organ of constriction is the lips, the tip of the tongue, the body of the tongue, and the root of the tongue. This grouping can be recreated or extended using the methods detailed previously. Graphemes within constellation 600 can be simplified for ease of use. In some embodiments, for example, the graphemes representing one or more of the sound segments for m, n, ng, l, r, w, and y may omit the diacritic for voicing, as those sound segments do not have voiceless counterparts.

The sound segments for w and y are semivowels, and either or both can be represented either as a vowel or a consonant. In the instant example, the w and y phonemes are represented using the, consonantal graphemes for the lips and tongue body, respectively, with a line diacritic to distinguish them from other consonants. Embodiments that represent these phonemes using vowel graphemes can use the same grapheme of u and w and the same grapheme for i and y.

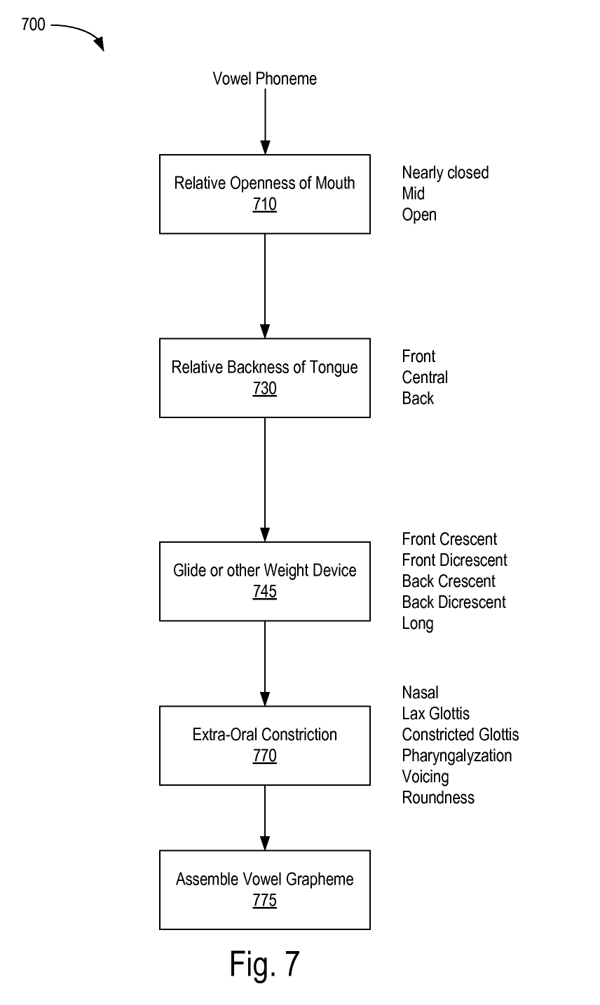

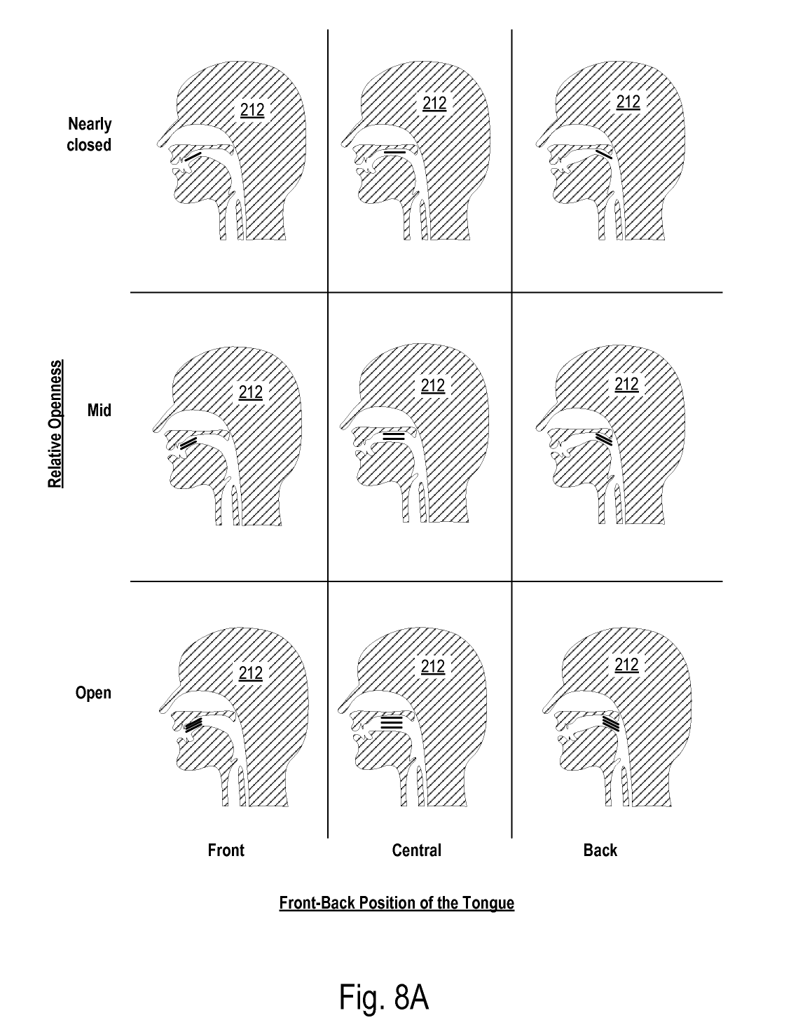

FIG. 7 is a flowchart 700 detailing how a vowel phoneme is derived in accordance with one embodiment. The first step (710) is to determine the relative openness of the mouth when forming the phoneme of interest. As depicted in FIG. 8A, the relative openness can be characterized as nearly closed (low), mid, or open. In this example, relative openness is represented using from one to three lines, as illustrated in the cross sections 212 of FIG. 8A.

The next step in the flowchart of FIG. 7, though the steps need not be in this order, is to determine the relative horizontal position, or “backness/frontness,” of the speaker's tongue in enunciating the vowel of interest (step 730). Returning to FIG. 8A, horizontal tongue position can be characterized as front, central, or back. This embodiment indicates horizontal tongue position using the slope of the line or lines used to designate openness. Using the lips as a reference, upward sloping lines represent a front tongue position, horizontal lines a central position, and downward sloping lines a back tongue position. Other graphical representations of openness and backness/frontness can be used in other embodiments.

Returning to FIG. 7, the third question for vowels indicates whether there is any mechanism of weight increasing in the vowel, such as lengthening or gliding. In this example, glides or weight devices are categorized as decrescent glides, front crescent glides, back decrescent glides, back crescent glides, and long vowels. Diacritical or other identifiers or graphic modifications are assigned as needed. In some embodiments detailed below, the line or lines developed in steps 710 and 730 are modified as needed to distinguish those with some distinguishing property noted in step 745.

FIG. 8B replicates head cross section 212 four times to illustrate exemplary iconic representations of phonological gestures used to express a pair of diphthongs, which are gliding monosyllabic speech sounds that start at or near the articulatory position for one vowel and move to or toward the position of another. In the example on the left, the vocal-tract shape morphs from a mid-constriction at the front of the vocal tract to a near-closed constriction during the enunciation of the same syllable, as in the vowel sound in “bay.” This example represents this diphthong using two sloped, parallel lines of the starting position and a diacritic 810 at the front of the grapheme to illustrate that the final sound is also formed using the front of the mouth. The right-hand example represents the diphthong for the vowel sound in “how” using three horizontal lines of the starting position and a diacritic at the end of the grapheme to illustrate that the final sound is formed using the back of the mouth. These and other diphthongs are discussed below.

Some vowel phonemes require some extra-oral constriction, and these are distinguished in step 770. In this example, these extra-oral constriction possibilities are identified as in the consonant example of FIG. 2. Finally, at step 775, an iconic grapheme is assembled based on the findings from steps 710, 730, 745, and 770.

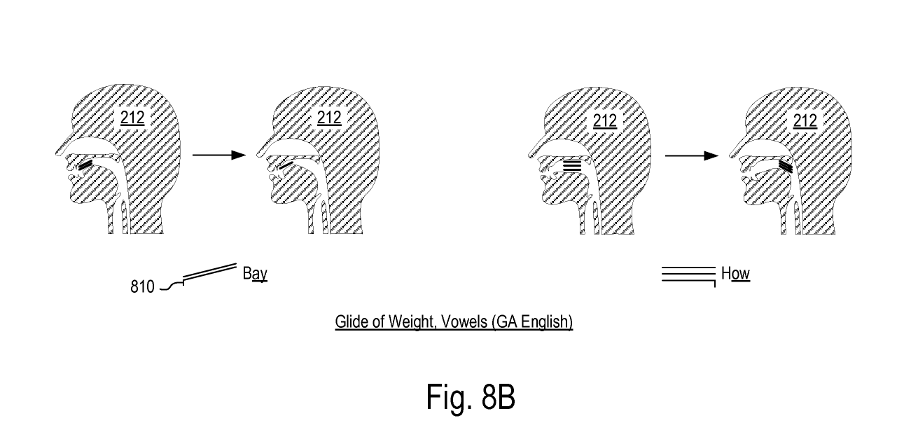

FIG. 9 is a flowchart 900 illustrating the construction of a vowel grapheme using the steps of FIG. 7. This example is applied to the vowel phoneme “ay,” as in bay, but is extensible to any vowel phoneme.

First, at step 710, the openness is determined to be at the mid level, and is accordingly assigned two parallel lines 910. The relative backness of the tongue is front for this phoneme, so step 730 indicates an upward slope, as illustrated using an arrow 920. The phoneme for “ay” includes a front-crescent glide, indicated by a small, vertical line segment at the front of the grapheme, but does not require an extra-oral constriction. Steps 745 and 770 thus indicate a need for the vertical line segment as a modification to the basic vowel grapheme. At step 775, a grapheme 930 is assembled based on the findings from the prior steps. Grapheme 930 iconically represents a mid degree of openness, a frontal tongue position, and a frontal glide. In GA English, this collection of features uniquely identifies the phoneme for “ay.”

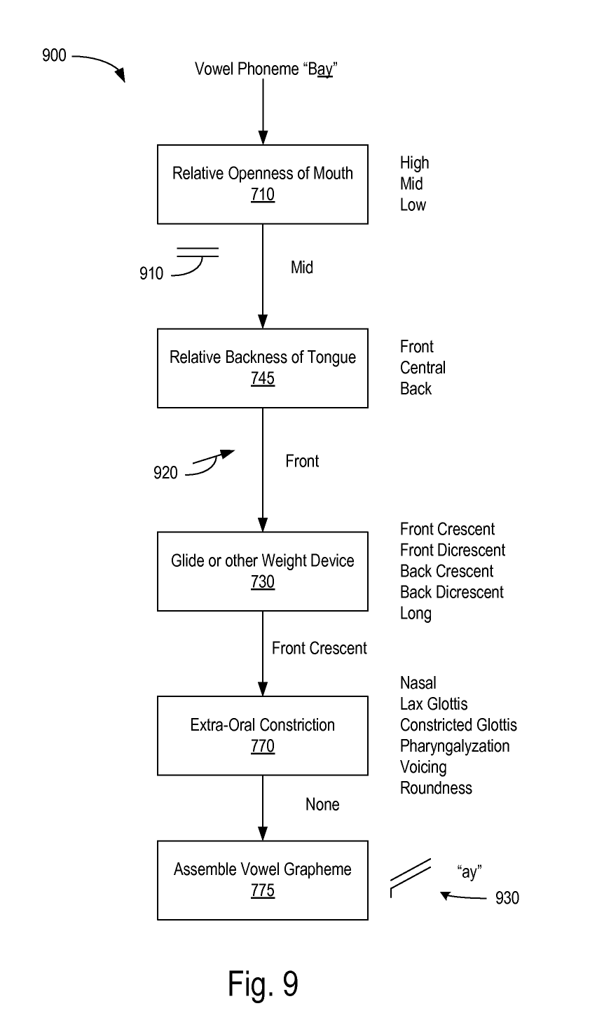

FIG. 10 depicts a vowel constellation 1000 for GA English arranged in rows and columns to indicate the degree of openness and the degree of frontness, respectively. Among the central phonemes, a curved diacritic is added to the so-called “rhotacized” versions of the phonemes. These vowel graphemes can be arrived at using the method described above in connection with FIG. 9.

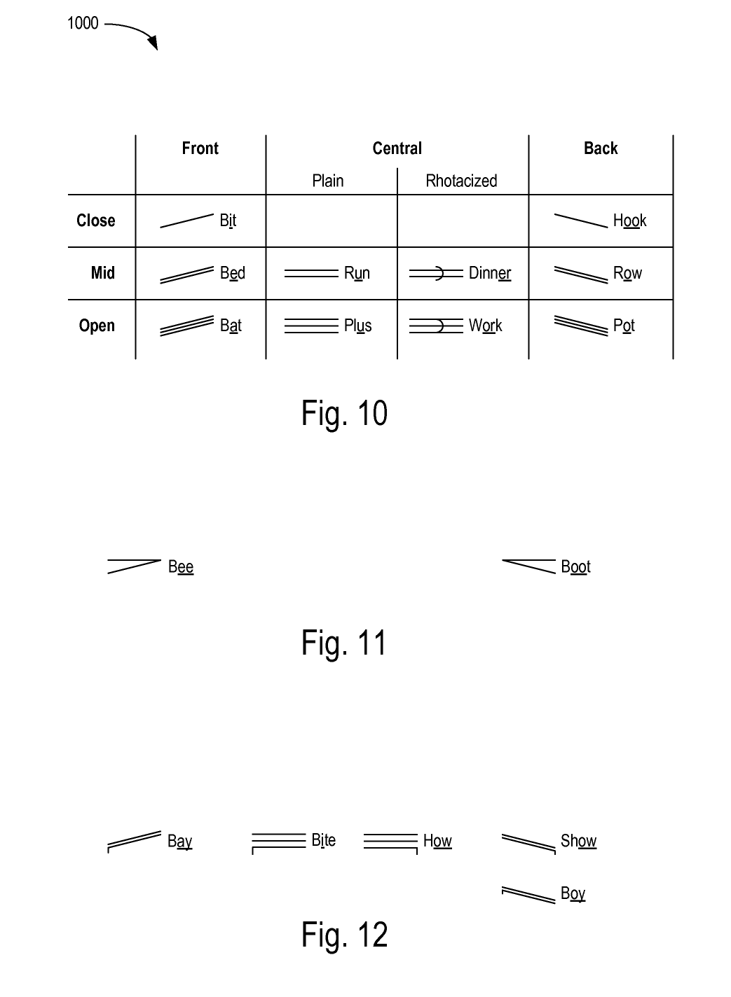

FIG. 11 depicts two vowel graphemes in accordance with one embodiment. The first represents the front/close vowel sound using a single, upward-sloping line and an additional horizontal segment to indicate the phoneme is a “long” vowel (e.g., the “ee” sound in “Bee”). The second represents the back/close vowel sound using a single, downward-sloping line, and an additional horizontal segment indicates that the phoneme is a “long” vowel (e.g., the “oo” sound in “Hook”). Though long vowels may not differ in constriction, they can nevertheless be identified as part of the process of examining for extra-oral constrictions. Alternatively, the processes discussed previously can be modified e.g. to include an additional step.

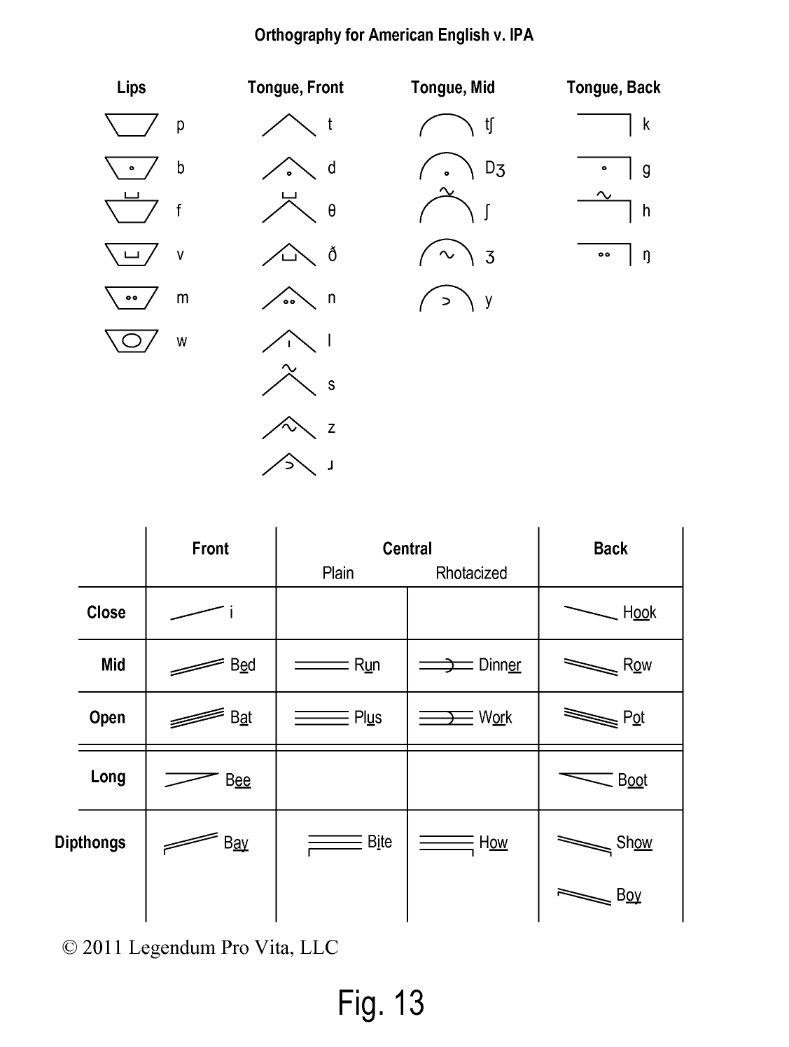

FIG. 12 depicts five vowel graphemes, one for each diphthong in GA English, in accordance with one embodiment.

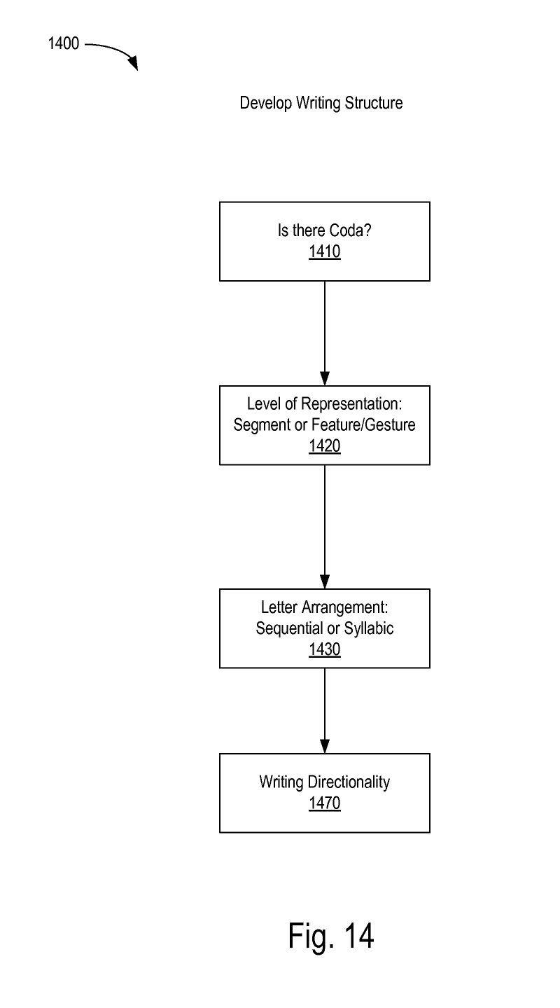

FIG. 13 shows an iconophonological orthography for GA English in accordance with one embodiment. The consonant graphemes are modified slightly as compared with the embodiment of FIG. 6; namely, voiced consonants are indicated by placing the diacritic within the primary symbol rather than with a separate diacritic. The difference between and “F” and a “V” phoneme, for example, is that the dental diacritic is placed within the lip icon for the latter phoneme. The consonants are mapped to the IPA symbols for the corresponding sounds. The vowels can similarly be mapped. The mapping may vary, however, due to perceived differences in pronunciation and due to phonological processes of assimilation and dissimilation. In English, different spellings can be used for the same phoneme (e.g., rude and food have the same vowel sounds), and the same letter (or combination of letters) can represent different phonemes (e.g., the “th” consonant sounds of “thin” and “this” are different). To avoid this confusion based on orthography, Phonologists represent phonemes by writing them between two slashes: “/ /”. On the other hand, references to variations of phonemes or attempts at representing actual speech sounds are usually enclosed by square brackets: “[ ]”. The symbols of FIG. 13 correspond to phonemes. In other embodiments the orthography can be expanded, condensed, or otherwise altered. Such modifications are to be expected, as the phonemes used to express languages and dialects are subject to interpretation and evolve with time.

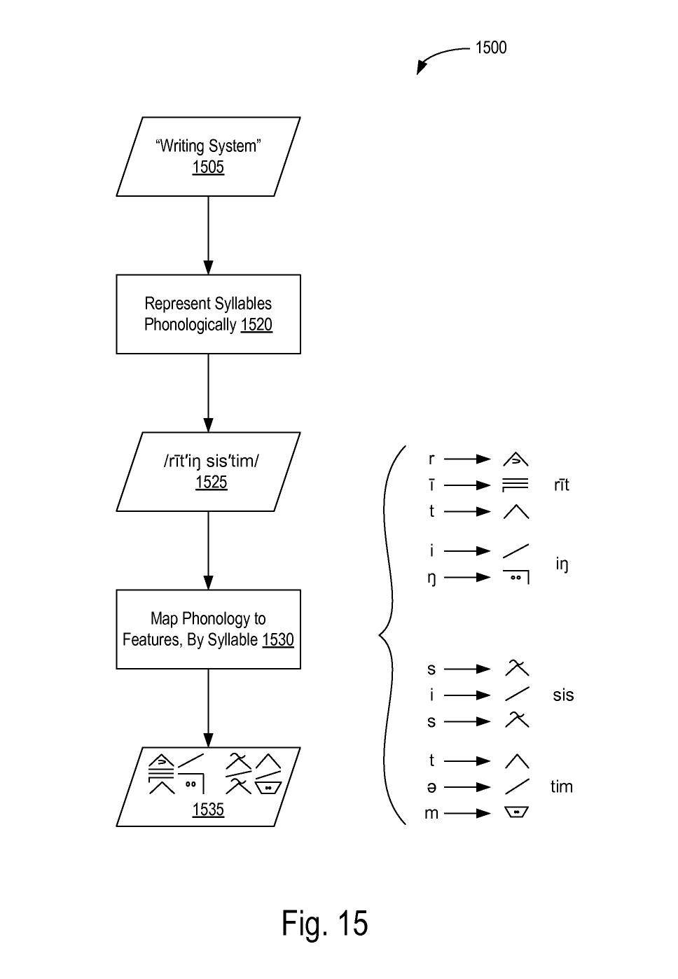

FIG. 14 is a flowchart 1400 illustrating a method of organizing graphemes developed as discussed previously to formulate written words and sentences that parallel the writing structure normally used for the target language.

First, at step 1410, an analyst deriving an orthography determines whether the target language includes consonants occupying the coda position of syllables. If not, the segments can be considered to be defined. If so, the analyst may ask a further question: Are the coda consonants perceived as distinct elements, or are they perceived as being closely related to the vowels? Distinct coda consonants may be represented in the same way as the onset consonants. Coda consonants perceived as having a closer relation with the vowels can be represented in an iconophonological orthography by diacritics that specify their phonological features, being these diacritics arranged around the space of the vowel phoneme of the syllable.

Next, at step 1420, the analyst determines the desirable level of phonological representation that an iconophonological orthography for the language under investigation should use. For example, complete, fully specified segments may be used, or the orthography can be condensed by reducing or eliminating redundant features. Examples of such redundancies are noted below. Next, in step 1430, the arrangement of graphemes in the conventional writing system for the target language is noted and, if desirable, replicated with the new orthography. The analyst may determine, for example, whether graphemes are to be arranged sequentially, whether syllable rhymes should be positioned below the onsets, or whether graphemes should be grouped in syllabic blocks.

The final step 1470 of FIG. 14 is to determine the directionality of the writing system conventionally associated with the target language. Should the graphemes be ordered left to right? Top to bottom? Along some other axis? Cultural preferences of the linguistic society that uses the target language, as well as legacy issues, present barriers to the adoption of a new orthography. Syllables, words, and sentences may best be arranged in the same manner as the conventional writing system to increase the likelihood of adoption.

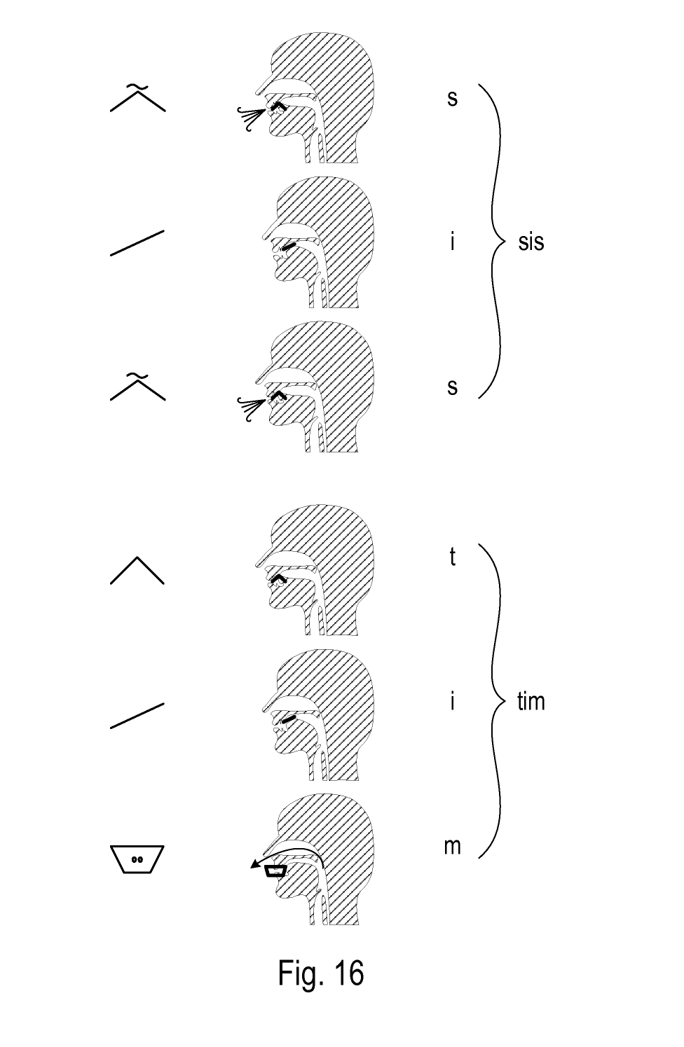

FIG. 15 is a flowchart 1500 illustrating a method of transliterating words expressed in a first orthography—GA English—into the iconophonological orthography depicted in FIG. 13. This example transliterates each of four syllables that make up the words “writing system” into homophonic representations based on the iconophonological graphemes discussed above. The method can, of course, be extended to any other words or phrases for which constituent features and gestures are represented in FIG. 13.

Beginning with step 1505, the words “writing system” are provided as input, such as during the transliteration of a document recorded using the English Alphabet. The alphabetic words are broken into syllables and represented phonologically (step 1520), as shown in phonology 1525. Step 1520 can be accomplished using available phonological dictionaries of the English language, which are readily available to those of skill in the art. Finally, in step 1530, the phonology of 1525 is mapped to the orthography of FIG. 13. This mapping is illustrated to the right of the flowchart, and leads to the representation of 1535.

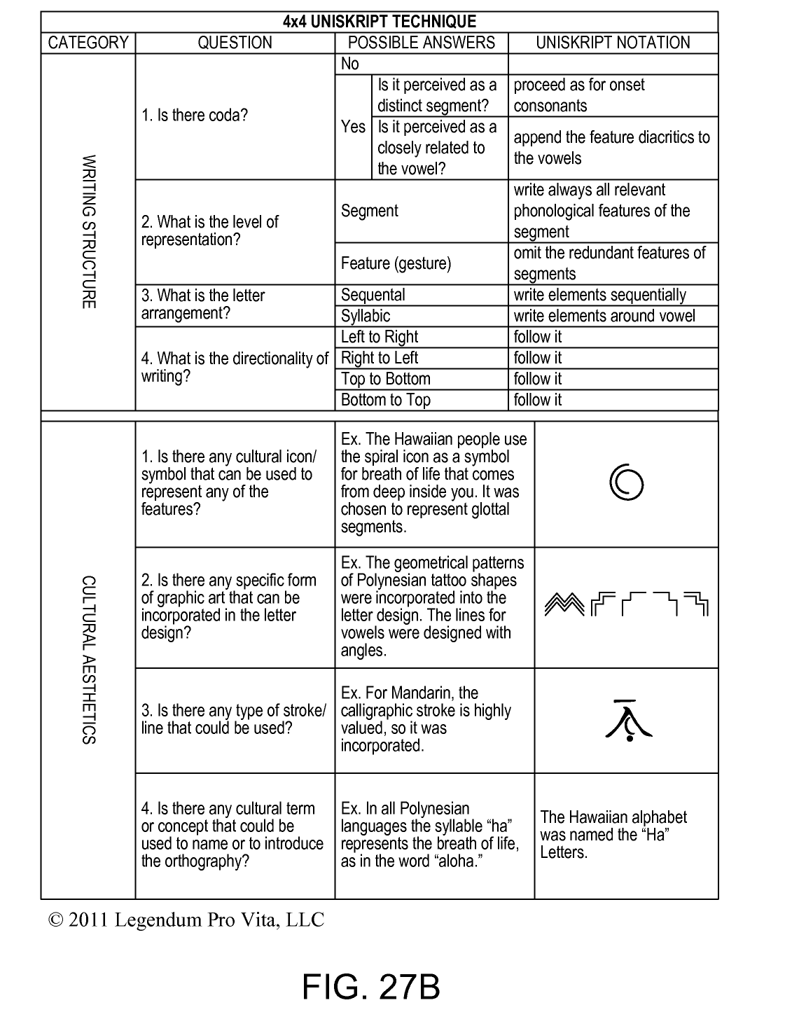

The process illustrated in flowchart 1500 can be implemented on a general-purpose or dedicated computer system. In one embodiment, for example, a database correlates English words to their corresponding transliterations, allowing an application program to make the requisite substitutions. Such systems can be applied to e.g. electronic and physical books and magazines and myriad resources available via the Internet. In other embodiments phonemes or collections of phonemes from spoken speech can be transcribed into English and transliterated into an iconophonological orthography, or can be transcribed directly into the iconophonological orthography. An exemplary computer system is detailed below in connection with FIG. 27.

The example of FIG. 15 groups graphemes syllabically from left to right, though other arrangements might also be used. The graphemes might also be arranged sequentially and segmentally, as are alphabetical symbols in English. The terms “writing system” derived in FIG. 15, arranged sequentially, would read:

[symbol]

[symbol]

This example illustrates that graphemes in accordance with these embodiments can be distorted to fit different form factors without losing their iconic properties.

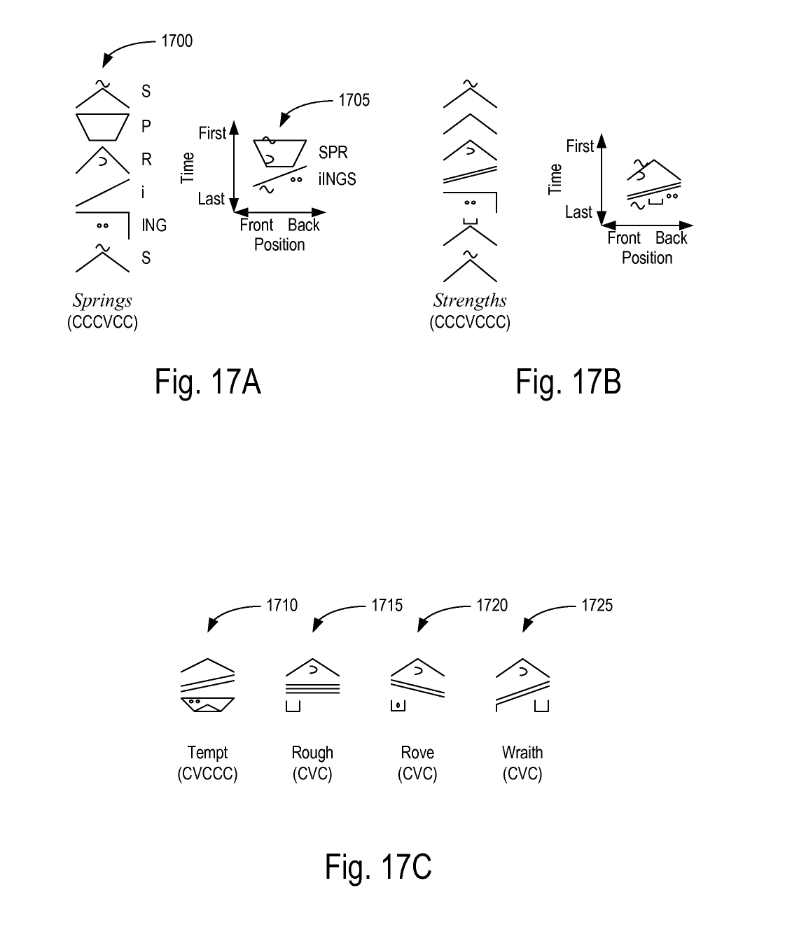

FIG. 16 illustrates how a reader of the iconophonological orthography in accordance with the embodiments described in connection with FIG. 13 can sound out the word “system” derived in the example of FIG. 15. The first syllable, pronounced “sis,” begins with the grapheme representing the tip of the tongue as the primary organ of construction and including a diacritic that stands for the alveolar fricative. The corresponding vocal-tract cross section reminds the reader of the placement of the tongue and includes graphic representation of a burst of air to represent the fricative. Placing the tongue as indicated, and adding the fricative, creates the “s” sound. This first phoneme of a syllable is termed the “onset.”

The vowel portion of “sis” is represented using a single line sloped upward. As described previously, this represents a relatively closed vowel sound formed at the front of the mouth. Forming the vocal tract according to this prescription produces the sound “i”. The final phoneme of the first syllable, referred to as the coda, is once again represented using the grapheme that iconically indicates the tongue tip and fricative. The reader combines these three sounds to produce the syllable “sis.”

The second syllable is sounded out in the same fashion as the first. The onset is similar to the last syllable, but lacks the fricative. Absent a secondary point of articulation, the tip of the tongue forms the “t” consonant sound. The nucleus of the syllable is the same as for the last syllable. The coda is, as shown in the vocal-tract cross section, formed using the lips and includes the nasal diacritic to indicate a secondary point of articulation. The sound formed using the lips and nose is the consonant sound for “m.” The reader is thus able to recreate the encoded word.

These graphemes used in FIG. 15 are iconographic, which makes them relatively easy to remember. The iconicity is based on features of the vocal tract rather than things or ideas, which greatly reduces the requisite number of symbols. Graphemes of the type described in connection with these embodiments thus provide extraordinary economy for representing, teaching, and learning orthographies. The orthography of FIG. 13, for example, employs just ten iconic symbols, logically grouped by organ of articulation, to represent all the consonant sounds. All the vowel sounds are represented by simple organizations of lines. Both the consonant and vowel graphemes are constructed following logical rules that make the orthography easy to learn. Indeed, a reader familiar with the patterns and symbols used to express the sounds can easily extend the symbol set to unknown or forgotten phonemes, or can sound out unknown or forgotten graphemes.

Though easy to learn, the graphemes of FIG. 13 can be cumbersome due to the potentially large number of glyphs used to represent a given syllable. Other embodiments therefore simplify the iconic structure of the graphemes. A brief discussion of basic syllable structure will be helpful in understanding how the iconophonological orthography described above can be further simplified.

A syllable is a sound structure that includes a central vowel (V) with one or more leading consonants (C), one or more trailing consonants, or both leading and trailing consonants. The vowel sound makes up the nucleus, which is the only requirement of a well-formed syllable. Leading and trailing consonants, if any, are used to form a syllable's “onset” and “coda,” respectively. Together, the nucleus and the coda constitute the “rhyme” of a syllable. A syllable can be graphically depicted as follows:

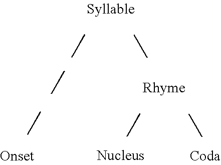

The most common type of syllable consists of a single consonant and a single vowel, and are referred to as CV syllables. Any consonant sound can occur at the onset of a CV syllable. The onset can also include additional consonant sounds. English, for example, includes CCV syllables (e.g., flee), and CCCV syllables (e.g., straw). Adjacent consonant sounds are limited, however. If an English CCV syllable begins with /b/, for example, the next consonant sound may be an /r/ or an /l/, but may not be a /k/ or an /s/. CCCV syllables are even more limited, and always begin with /s/.

Many languages allow consonants in the coda position, in which case a different set of restrictions apply. In English, for example, a lone consonant in a coda can be most any consonant. If there are two consonants in the coda, however, the second must be an obstruent, a sound produced by the stoppage of air. Examples include waft and adze. If there are three coda consonants, the last must be an /s/.

The restrictions on consonant and vowel placement within syllables are well known. Those of skill in the art refer to this topic as “phonotactics.” In the context of iconophonological orthographies of the type described herein, a phonotactical understanding of phototactical restrictions for the target language, such as the limitations for consonant placement in the onset or coda of a given syllable, often allows for a more efficient orthographic representation. Native speakers and readers are generally not conscious of these restrictions, so it is beneficial that analysts generating orthographies of the type disclosed herein know the phonotactical restrictions for the target language. Such knowledge is referred to as “linguistic competence.”

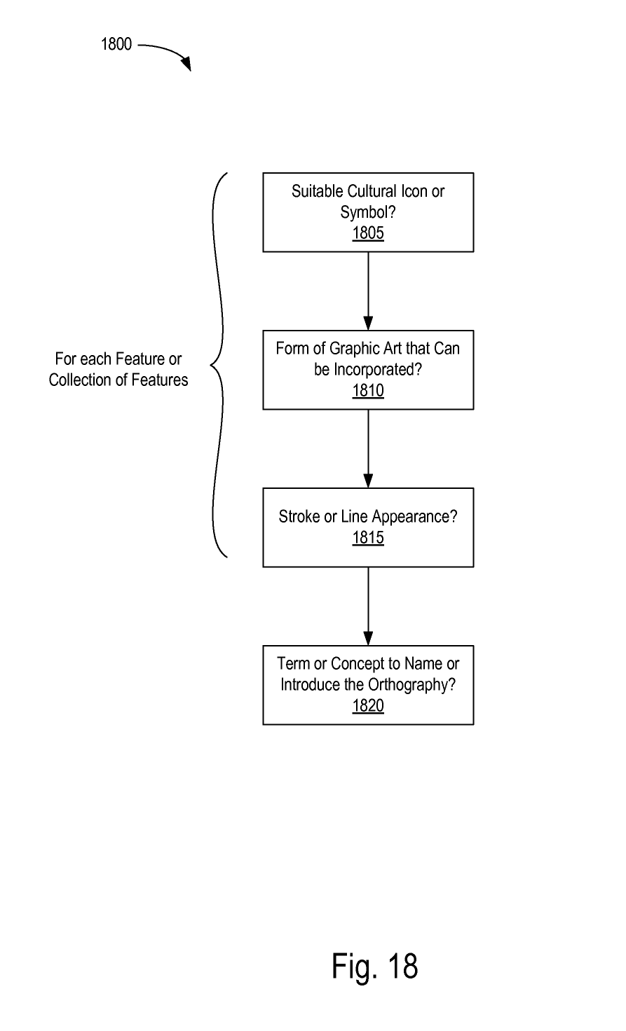

FIG. 17A illustrates how the graphical representations of the single-syllable word “springs,” a CCCVCCC syllable, can be simplified in accordance with one embodiment. The idea is to divide syllables into their constituent components and represent them iconically using techniques detailed above. At the left, a column of symbols 1700, taken from the orthography of FIG. 13, represents the word “springs” iconophonologically using the techniques detailed previously. Due to the number of consonants, the expressed syllable is relatively “tall” and includes a considerable number of glyphs, and a lot of redundancy in terms of features represented. While relatively easy to decipher, particularly to the new reader, this syllabic representation can be cumbersome. Some embodiments therefore condense such syllables by removing redundant information.

For example, CCCVCCC syllables always begin and end with /s/, so the /s/grapheme need not be completely represented to distinguish it from other possibilities. Referring to the condensed representation 1705 at the right, the “˜” is included within the /p/symbol to represent the /s/ in the onset. The tip of the tongue is not specified because the other consonants illustrated using the fricative diacritic (/z/, /si/, and /h/) cannot hold this consonant position. Specifying the primary organ of articulation in this instance would therefore be redundant. The “⊃” diacritic, which represents the curved tongue for the /r/ consonant, is also included in the /p/ symbol.

The arrangement of the diacritics also provides some information to the reader. Syllables are arranged in this embodiment so that the passage of time, from first phoneme to last, is generally represented from top to bottom. Placing the fricative diacritic above the curved-tongue diacritic indicates that the former is enunciated first in the syllable.

Representation 1705 also simplifies the coda, in part by making reference to the position in the vocal tract used to express the specified gesture. With reference to FIG. 13, the nasal diacritic can be used to indicate the consonant sounds /m/, /n/, /si/, or /ng/. Starting with the sound for /m/, which is formed by the lips at the front of the vocal tract, these sounds are formed progressively toward the back of the vocal tract. The nasal diacritic in representation 1705 is placed toward the right of the symbol to indicate that it is a “back” sound, and is above the fricative diacritic to indicate that it precedes the fricative sound in time. This arrangement uniquely identifies the coda without the need for a separate iconic representation of the primary organs of articulation for the /ng/ and /s/ sounds. The regions of the nucleus and coda overlap in this instance for space efficiency, but can be maintained in separate areas in other embodiments.

FIG. 17B illustrates how “strengths,” a CCCVCCC syllable, can be simplified using the procedure discussed in connection with FIG. 17A. The /s/ and /r/ sounds are as in the prior example, but the middle consonants sound is the /t/, which is articulated using the tip of the tongue. The onset symbol is modified accordingly. The nasal diacritic is placed high and on the right, which means the first consonant sound in the coda is at the back of the voice tract. This can only be the /ng/ sound. The diacritic for teeth is positioned temporally after and in the middle position. The middle teeth placement distinguishes this consonant sound from the other “teeth” sound, the /v/ formed at the front of the vocal tract. Finally, the fricative diacritic is also at the front, which distinguishes that /s/ sound from the /sh/ and /h/ sounds. In this case, “front” is not the same for an /s/ as for an /f/, but is relative to other sounds identified using the same diacritic. In other embodiments the regions of a syllable can be used more consistently. For example the regions can be divided into four columns, one for each primary organ of constriction.

The positions of the diacritics are helpful, but may be redundant. In the example of FIG. 17B, the /s/ is the only possible final consonant in the coda, so its position is not needed to uniquely distinguish it from other fricative consonants. Likewise, positioning the teeth diacritic in the middle as an indication of vocal-tract position is helpful but redundant, as no English syllable ends in /gvs/. Other arrangements and simplifications might similarly be employed.

FIG. 17C depicts iconophonological representations 1710, 1715, 1720, and 1725 of single-syllable words to illustrate how such syllables can be condensed in accordance with one embodiment. In the symbol 1719 for the CVCCC syllable “tempt,” the coda is specified using the nasal diacritic—to indicate its temporal position in the coda—and to the left to distinguish it from the nasal sounds formed farther back in the vocal tract. The last consonant sound in the coda is depicted using the symbol for the tip of the tongue, which can be placed inside the /p/ grapheme without creating ambiguity in this example.

Representations 1715, 1720, and 1725 depict the single-syllable words “rough”, “rove”, and “wraith”, respectively. Each begins with the /r/ sound, and represents the onset accordingly. The nuclei are vowel sounds from FIG. 13, and thus require no additional description here. The different codas all include the teeth diacritic positioned to distinguish between the forward sounds /f/ and /v/ and the more rearward sound /th/. The coda of representation 1720 includes a dot to indicate that the teeth sound is to be vocalized.

Methods for teaching iconophonological orthographies of the type disclosed herein can present early readers with relatively complete syllabic or sequential graphemes. Graphemes that omit some structural detail in favor of space efficiency can be introduced gradually as the reader gains experience with the orthography. Computer-based embodiments can allow the reader to select orthographic representations based on the reader's skill or preference. A new reader may, for example, prefer an orthography that is relatively rich in detail to best depict features and gestures, whereas a more experienced reader may prefer a more condensed and economic representation. The same flexibility can be provided for sequential and syllabic representations of the orthographies, and for the arrangements of graphemes on a page.

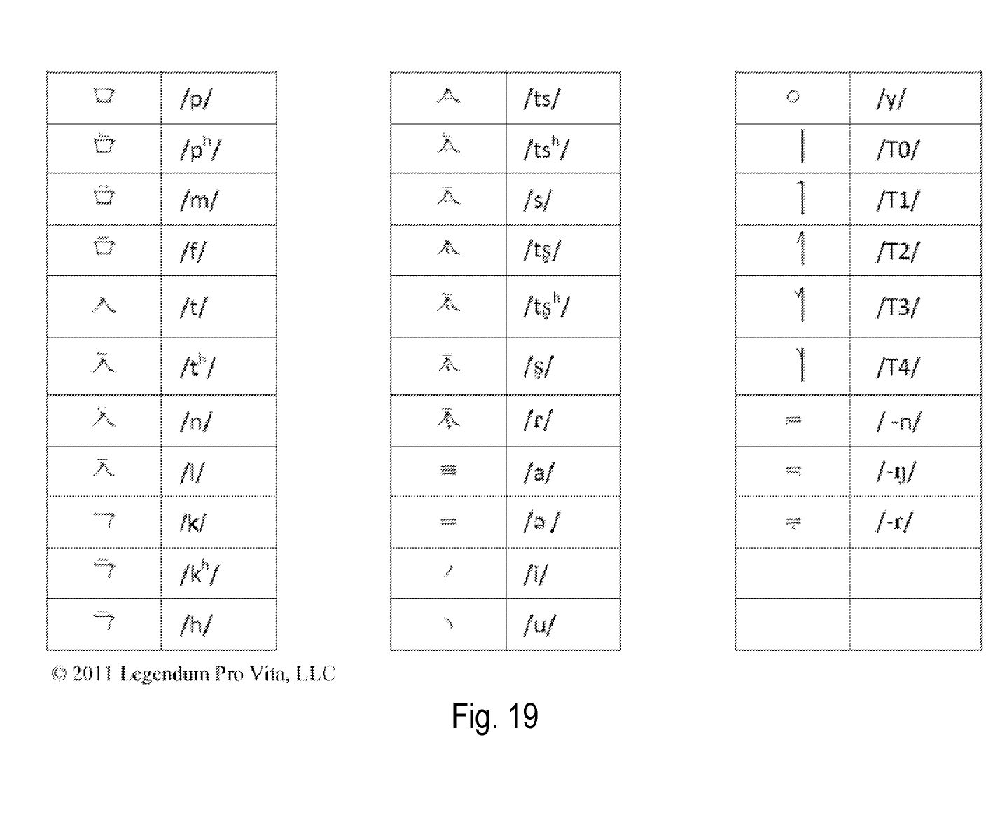

FIG. 18 is a flowchart 1800 illustrating a method by which orthographies in accordance with some embodiments can be stylized to reflect cultural aesthetics of the population for which the new orthography is to be introduced. Such adaptations can increase sociolinguistics acceptance of the orthography.

In step 1805, the analyst determines whether a suitable cultural icon on a symbol exists for a given feature. A polygon is used to symbolize the mouth in the foregoing embodiment, for example, but the symbol for a mouth might be replaced with one that is more suitable or typical of the culture associated with the target population. Similarly, in step 1810, the analyst may incorporate some form of graphic art into the orthography. Hawaiian statues often depict the tongue as a downward-pointed triangle, for example, in which case the symbol for the tongue could adopt this shape.

The next determination is whether strokes or lines in the graphemes have or can be given some culturally identified characteristic (1815). Returning to the Hawaiian example, steps or waves are traditional Hawaiian symbols, and can be incorporated into the features used to express a Hawaiian orthography. Examples of Mandarin graphemes stylized in accordance with steps 1805, 1810, and 1815 are detailed below.

The final step of method 1800 is to coin a name for the orthography target to a language of interest. “Uniskript™” is a sample name for an English orthography.

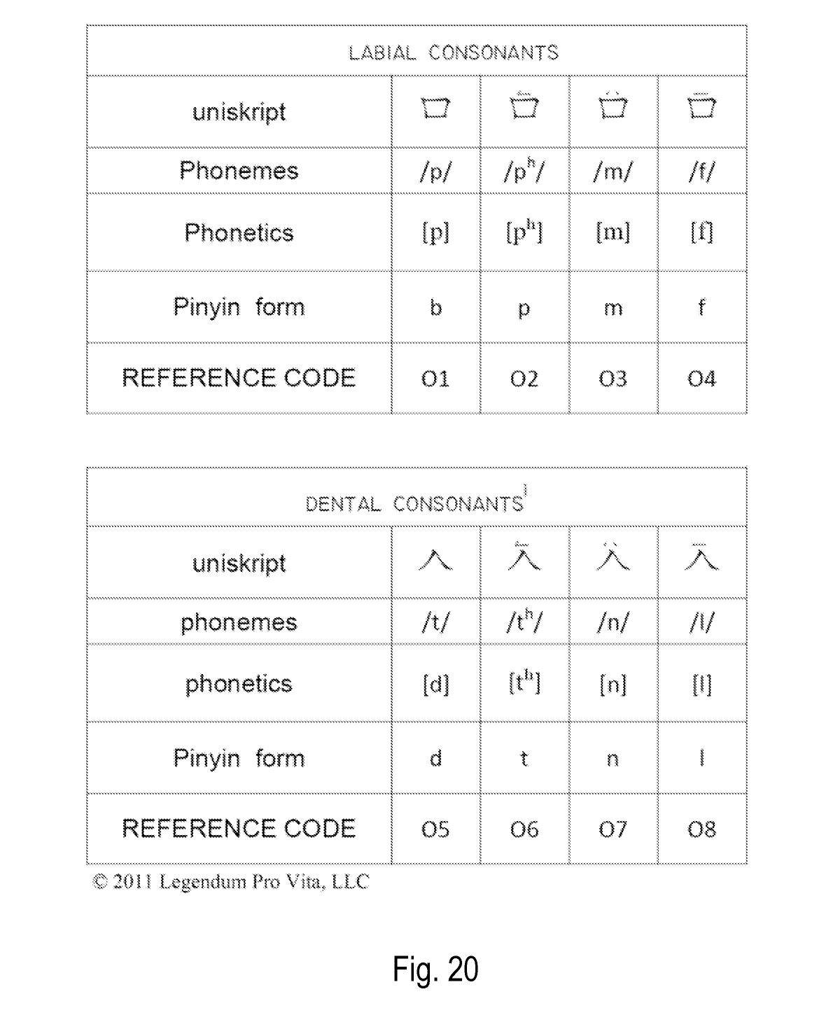

FIG. 19 depicts an orthography in accordance with an embodiment that includes thirty-one graphemes to represent Beijing Mandarin. As with the GA English orthography detailed previously, this embodiment is similarly iconophonological, and consequently relatively easy to learn and comprehend. The Mandarin graphemes are also stylized for a Chinese sensibility, which further reduces resistance to adoption. These thirty-one letters are used to form fifty-seven graphic elements for expressing Mandarin in accordance with this embodiment. These elements make up an Orthography presently called “Uniskript™ Mandarin” (UM), and are detailed below.

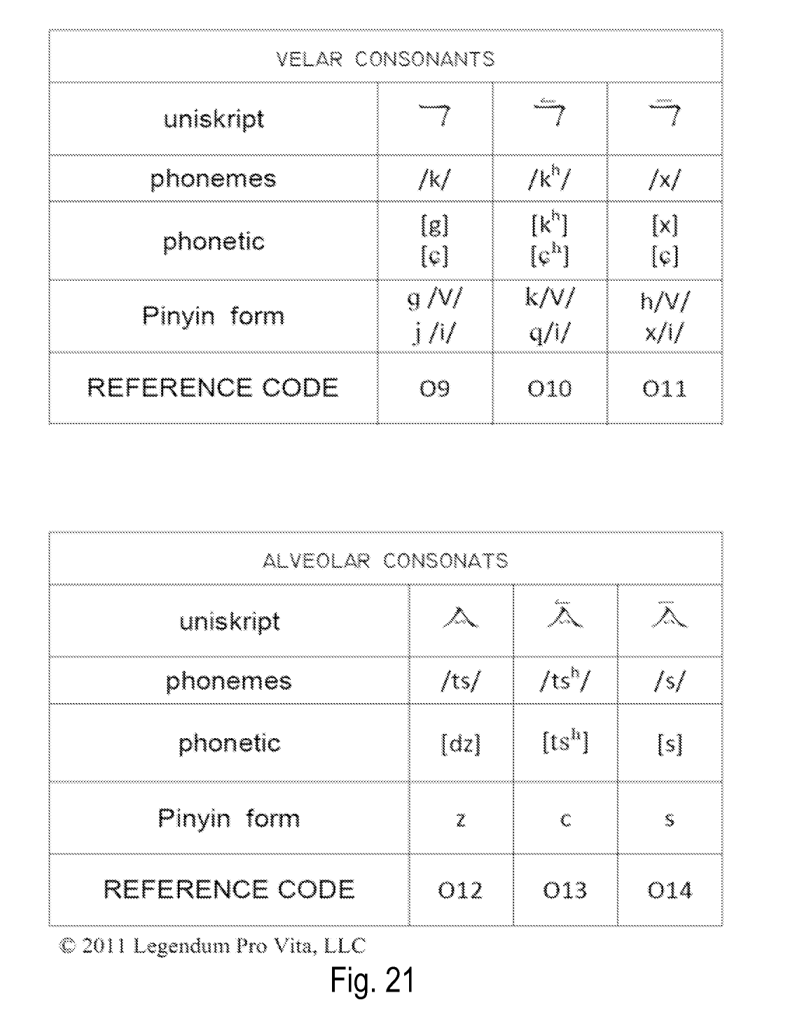

FIG. 20 depicts graphic elements used to represent labial consonants, and references them to phonemes, phonetics, and Pinyin forms to facilitate pronunciation. A reference code is an alphanumeric code in which the letters represent placement within a syllable, O for onset, R for rhyme, and T for tone. In one embodiment, a UM keyboard uses a single key for each onset and another for each rhyme. All elements of the rhyme are grouped together in only one keystroke in order to follow the traditional approach of the Chinese literature and linguistics, which highlights the internal structural unity of the elements occupying this position. This decision also reflects the linguistic intuitions of the Mandarin native speakers, who perceive even the most complex rhymes as one single segment. Other embodiments might also be used.

All elements numbered with a reference code are composed by one or more of the letters depicted in FIG. 19. UM uses only thirty-one graphemes to write any possible word of Beijing Mandarin. The onsets of the syllables are formed by one of the following eighteen consonant graphemes, while the rhymes of the syllables are formed by combinations of the five vowels and the three coda possibilities. Each syllable receives one of five tone specifications.

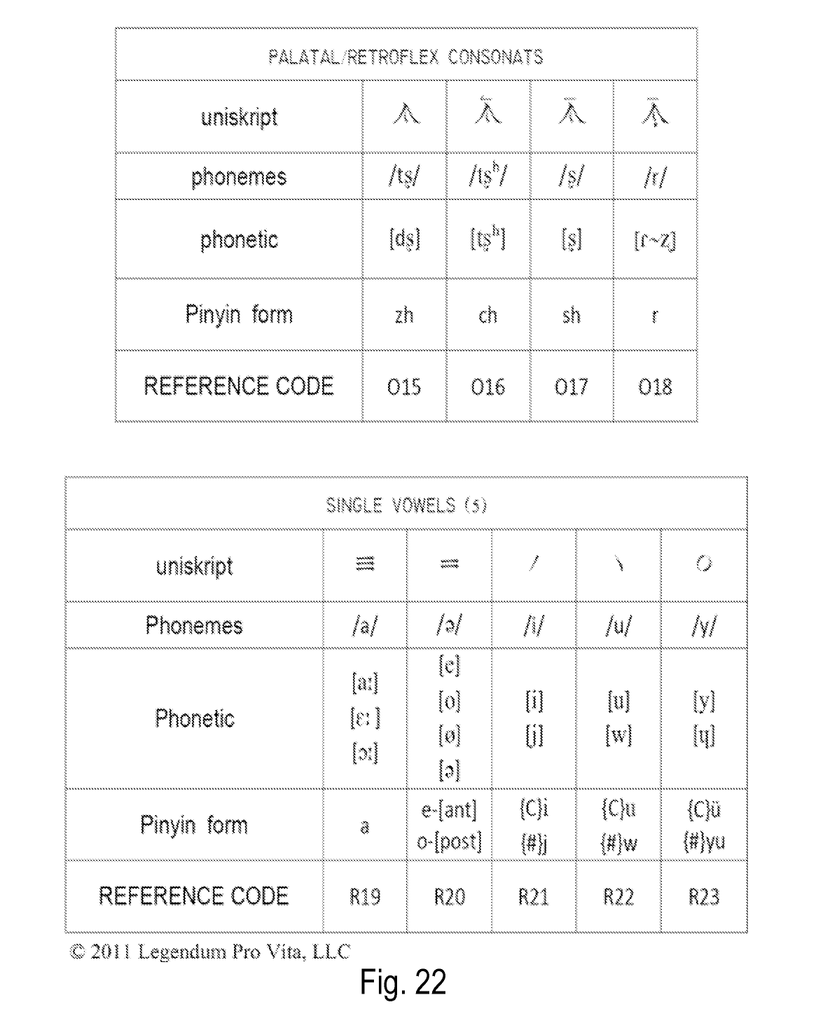

FIG. 21 depicts graphemes used to represent velar and alveolar consonants, and references them to phonemes, phonetics, and Pinyin forms to facilitate pronunciation, and to a reference code described previously for use with an embodiment of a UM keyboard.

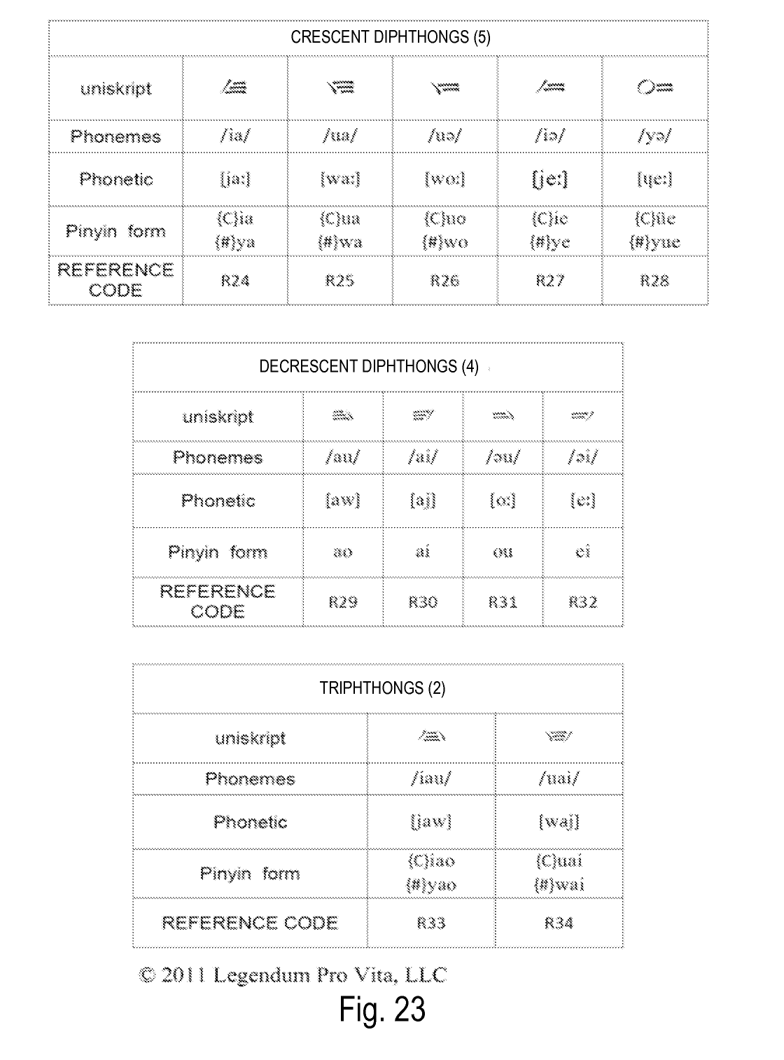

FIG. 22 depicts graphemes used to represent palatal/retroflex consonants and single vowels with the same references provided previously.

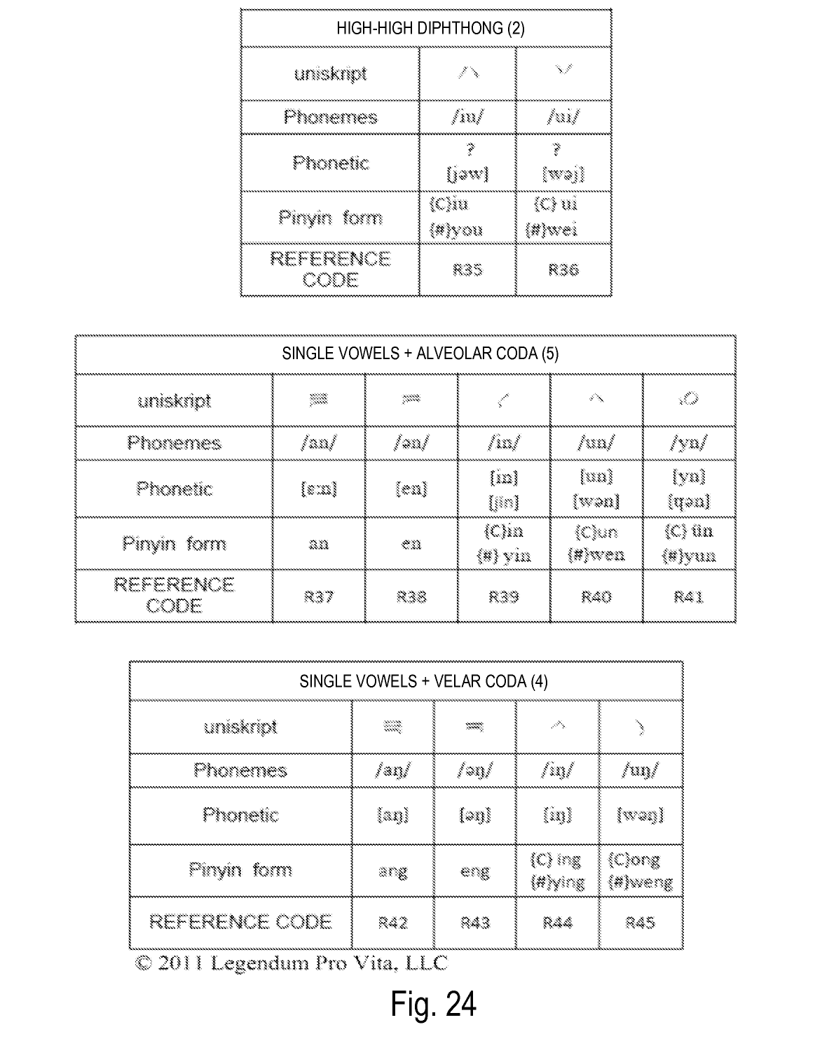

FIG. 23 depicts graphemes used to represent crescent diphthongs, decrescent diphthongs, and triphthongs with the same references provided previously.

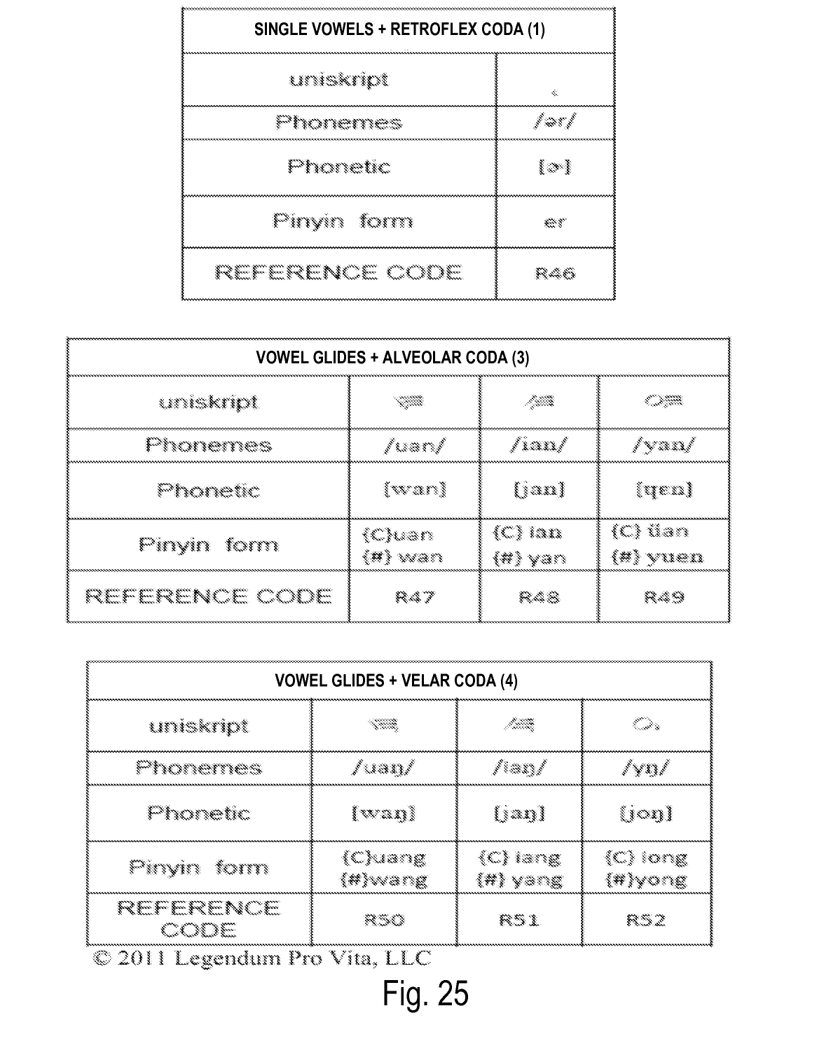

FIG. 24 depicts graphemes used to represent high-high diphthongs, single vowels with alveolar coda, and single vowels with velar coda with the same references provided previously.

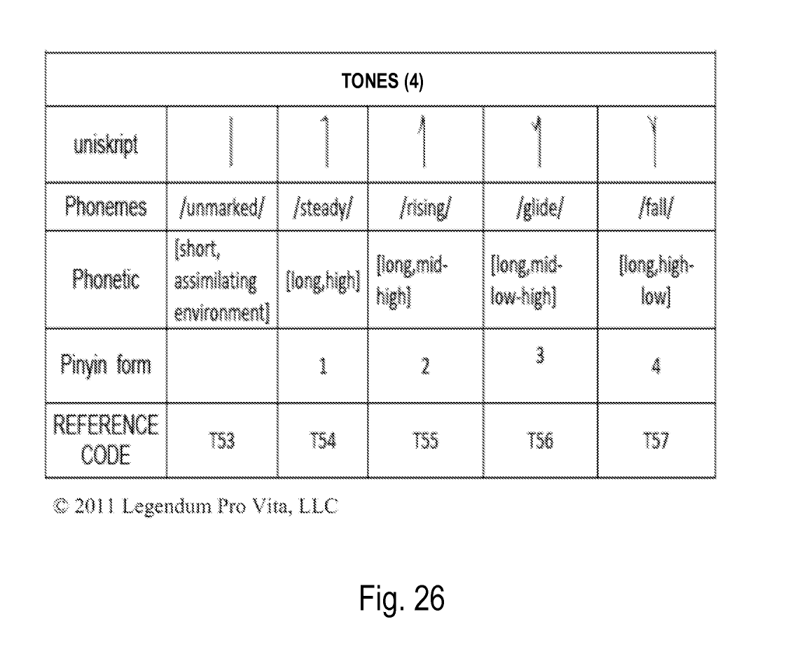

FIG. 25 depicts graphemes used to represent single vowels with retroflex coda, vowel glides with alveolar coda, and vowel glides with velar coda using the same references provided previously.

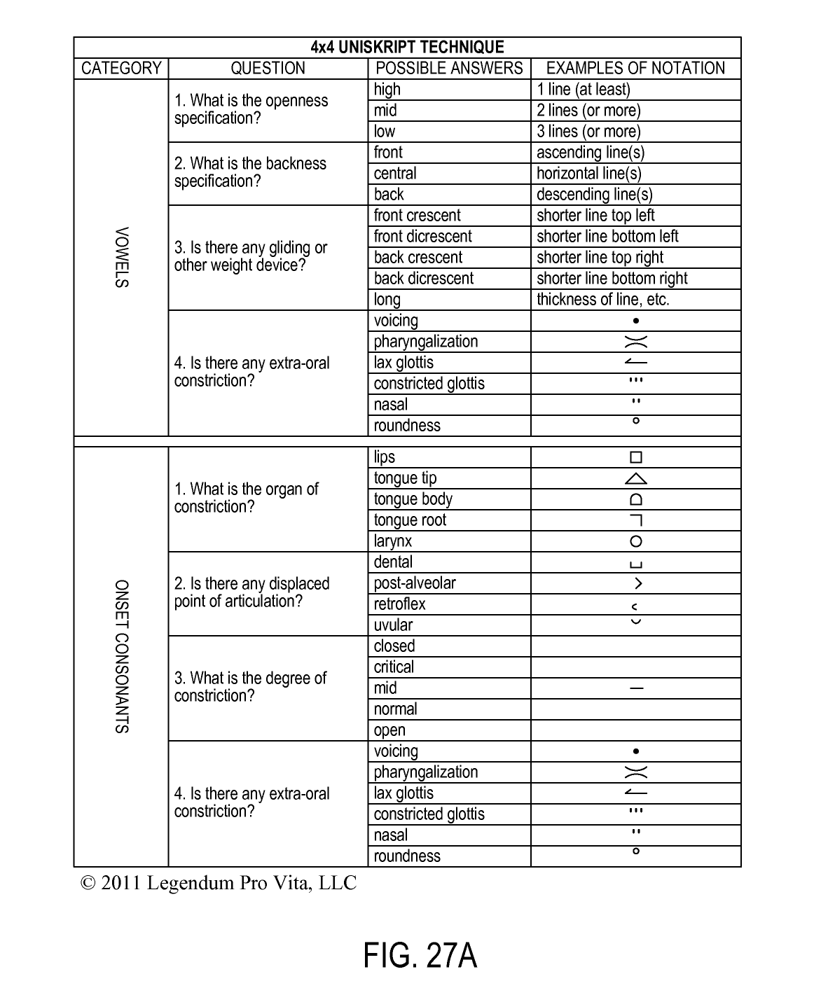

FIG. 26 depicts graphemes used to represent tones using the same references provided previously.

FIGS. 27A and 27B are two sheets of a questionnaire that may be employed by an analyst to develop orthographies in the manner detailed above. The questionnaire is divided into four categories, vowels, onset consonants, writing structure, and cultural aesthetics. Each category is subdivided into four questions, the answers to which inform the type of notation used to create the orthography of interest. In developing an orthography, the categories can be addressed together or in any order. Aspects of orthographies developed in accordance with embodiments disclosed herein can be refined, and are expected to evolve over time.

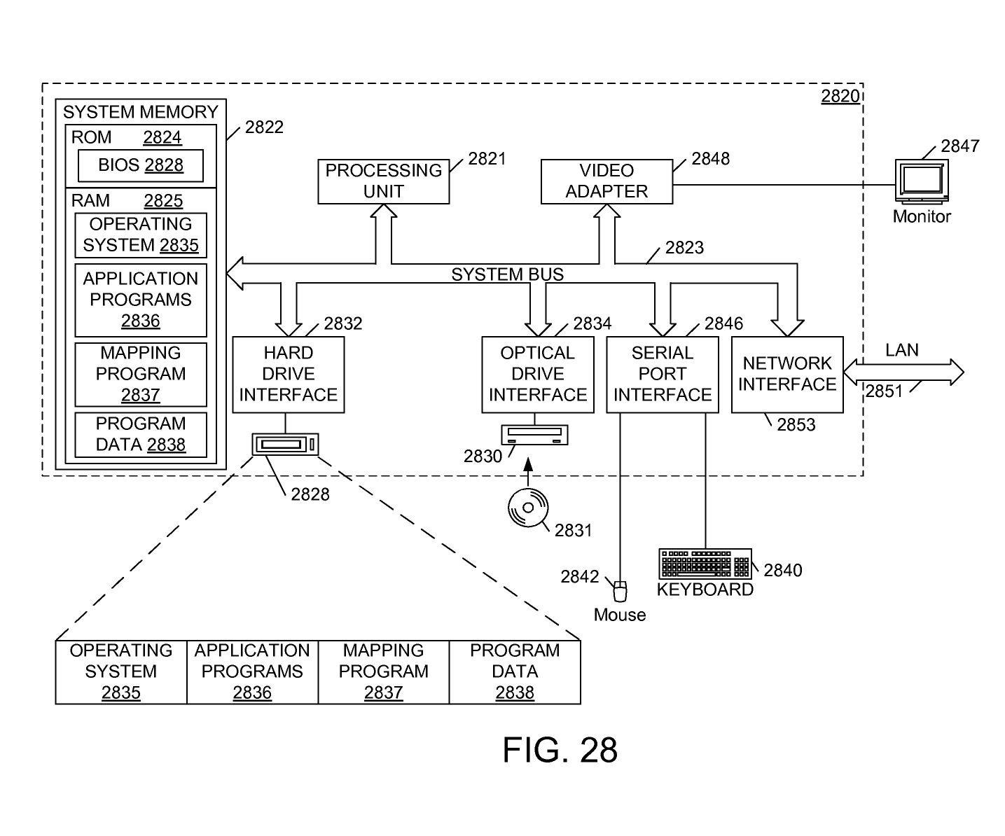

FIG. 28 and the following discussion provide a brief, general description of a suitable computing environment in which the claimed subject matter may be implemented. Although not required, iconophonological orthographies and associated methods in accordance with the foregoing embodiments can be implemented using computer-executable instructions, such as program modules, executed by a computer. Generally, program modules include routines, programs, objects, components, data structures, etc., that perform particular tasks or implement particular abstract data types. Those of skill in the art will appreciate various types of computer systems and configurations, including hand-held devices, multiprocessor systems, microprocessor-based or programmable consumer electronics, network PCs, minicomputers, mainframe computers, and the like, can be used to exhibit, translate, and transliterate as detailed above. Methods of exhibiting, translating, and transliterating iconophonological orthographies may also be practiced in distributed computing environments where tasks are performed by remote processing devices that are linked through a communications network. In a distributed computing environment, program modules may be located in both local and remote memory storage devices.

With reference to FIG. 28, an exemplary computing system for exhibiting, translating, and transliterating iconophonological orthographies in accordance with the foregoing embodiments includes a general purpose computing device in the form of a conventional personal computer 2820, including a processing unit 2821, a system memory 2822, and a system bus 2823 that couples various system components including the system memory to the processing unit 2821. The system bus 2823 may be any of several types of bus structures, including a memory bus or memory controller, a peripheral bus, and a local bus using any of a variety of bus architectures. The system memory includes read only memory (ROM) 2824 and random access memory (RAM) 2825. A basic input/output system 2828 (BIOS), containing the basic routines that help to transfer information between elements within the personal computer 2820, such as during start-up, is stored in ROM 2824. The personal computer 2820 further includes a hard disk drive 2828 for reading from and writing to a hard disk, not shown, a magnetic disk drive 2828 for reading from or writing to a removable magnetic disk 2829, and an optical disk drive 2830 for reading from or writing to optical disk 2831 such as a CD ROM or other optical media. The hard disk drive 2828, magnetic disk drive 2828, and optical disk drive 2830 are connected to the system bus 2823 by a hard disk drive interface 2832, a magnetic disk drive interface 2833, and an optical drive interface 2834, respectively. Other drives, such as Flash memory, might also be used. The drives and their associated computer-readable media provide volatile and nonvolatile storage of computer readable instructions, data structures, program modules and other data.

A number of program modules may be stored on the hard disk, magnetic disk 2829, optical disk 2831, ROM 2824 or RAM 2825, including an operating system 2835, one or more application programs 2836, other program modules 2837, and program data 2838. A user may enter commands and information into the personal computer 2820 through input devices such as a keyboard 2840 and pointing device 2842. Other input devices (not shown) may include a microphone, joystick, game pad, satellite dish, scanner, or the like. These and other input devices are often connected to the processing unit 2821 through a serial port interface 2846 that is coupled to the system bus, but may be connected by other interfaces, such as a parallel port, game port or a universal serial bus (USB). A monitor 2847 or other type of display device is also connected to the system bus 2823 via an interface, such as a video adapter 2848. In addition to the monitor, personal computers typically include other peripheral output devices (not shown), such as speakers and printers.

The personal computer 2820 may operate in a networked environment using logical connections to one or more remote computers. The remote computer 2849 may be another personal computer, a server, a router, a network PC, a peer device or other common network node, and typically includes many or all of the elements described above relative to the personal computer 2820. The logical connections depicted in FIG. 28 include a wired or wireless local area network (LAN) 2851, though other types of connections are also common and may be supported. Such networking environments are commonplace in offices, enterprise-wide computer networks, intranets and the Internet.

When used in a LAN networking environment, the personal computer 2820 is connected to the local network 2851 through a network interface or adapter 2853. When used in a wide-area network (WAN) networking environment, the personal computer 2820 typically includes a modem or other means for establishing communications over the wide area network 2852, such as the Internet. In a networked environment, program modules depicted relative to the personal computer 2820, or portions thereof, may be stored in the remote memory storage device. It will be appreciated that the network connections shown are exemplary and other means of establishing a communications link between the computers may be used.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention, which is instead defined by the appended claims.

1-21. (canceled)

22. A phonological orthography comprising:
a plurality of graphemes, including vowel graphemes and consonant graphemes, each grapheme iconically depicting a phonological feature.

23. The orthography of claim 22, wherein each consonant grapheme depicts one of a plurality of organs of articulation.

24. The orthography of claim 23, wherein the organs of articulation include at least two of lips, tongue, and glottis.

25. The orthography of claim 24, wherein at least a subset of the consonant graphemes depicts a secondary point of articulation.

26. The orthography of claim 25, wherein the secondary point of articulation includes at least one of an extra-oral constriction, a place of constriction, and a degree of constriction.

27. The orthography of claim 22, wherein the orthography consists of a set of graphemes, and wherein substantially all of the graphemes in the set of graphemes iconically depict at least one of a primary and a secondary point of articulation.

28. A method of transliterating words represented using a first orthography to corresponding homophonic representations using an iconophonological orthography, the method comprising:
providing a plurality of graphemes, including vowel graphemes and consonant graphemes iconically depicting phonological features of a vocal tract; and
presenting each of the homophonic representations as assemblies of one or more of the graphemes;
wherein each homophonic representation illustrates at least one phonological gesture employed within a vocal tract to enunciate a corresponding one of the words.

29. The method of claim 28, wherein each of the vowel graphemes iconically depicts a shape of the vocal tract.

30. The method of claim 29, wherein each of the vowel graphemes iconically depicts a direction of air flow within the vocal tract.

31. The method of claim 29, wherein each of the vowel graphemes iconically depicts a degree of openness of the vocal tract.

32. The method of claim 28, wherein each of the consonant graphemes iconically depicts at least one of lips, a forward tongue position, a central tongue position, and a back tongue position.

33. The method of claim 28, wherein each consonant grapheme in at least a subset of the consonant graphemes depicts voicing of the respective consonant phoneme.

34-40. (canceled)

41. A tangible medium of expression comprising:
written sentences expressed using an icophongraphic orthography to represent words of a language, the orthography including vowel graphemes and consonant graphemes, each grapheme iconically depicting a phonological feature.

42. The medium of claim 41, wherein each consonant grapheme depicts one of a plurality of organs of articulation.

43. The medium of claim 42, wherein the organs of articulation include at least two of lips, tongue, and glottis.

44. The medium of claim 43, wherein at least a subset of the consonant graphemes depicts a secondary point of articulation.

45. The medium of claim 44, wherein secondary points of articulation includes at least one of an extra-oral constriction, a place of constriction, and a degree of constriction.

46. The medium of claim 41, wherein at least one of the consonant graphemes includes a diacritic, and wherein a placement of the diacritic within the grapheme indicates a position in a vocal tract.

47. The medium of claim 41, wherein the words comprise syllables, at least one syllable expressed using one of the consonant graphemes depicting a primary organ of articulation in an onset position and a diacritic in a coda position.

48. The medium of claim 47, wherein the diacritic depicts a point of articulation.

49. The medium of claim 48, wherein a physical placement of the diacritic distinguishes between points of articulation.

50. The medium of claim 48, wherein the coda position lacks an iconic depiction of a second primary organ of articulation.

51. The medium of claim 41, wherein the orthography consists of a set of graphemes, including the vowel graphemes and consonant graphemes, and wherein substantially all of the graphemes in the set of graphemes iconically depict at least one of a primary and a secondary point of articulation.
